(19) United States
(12) Patent Application Publication
(10) Pub. No.: US 2009/0097062 A1
(43) Pub. Date: Apr. 16, 2009

(54) PRINT SYSTEM, PRINT METHOD, AND MOBILE TERMINAL USED IN PRINT SYSTEM

(75) Inventor: Hiroki Hayashi, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/249,653

(22) Filed: Oct. 10, 2008

(30) Foreign Application Priority Data
Oct. 12, 2007 (JP) 2007-266601

(51) Int. Cl. G06F 3/12

(52) U.S. Cl. 358/1.15

(57) ABSTRACT

A print system that acquires the contents for printing from a server provided on a network via a mobile terminal and that prints the contents through a printer is provided to reduce unauthorized duplication of the contents. The server issues the print right corresponding to the print data in response to a request for the contents from the mobile terminal. The mobile terminal requests the print data by transmitting the acquired print right to the server. The server determines whether the transmitted print right is valid, and transmits the print data when the print right is valid. The mobile terminal transfers the transmitted print data to the printer. When the print data is transmitted to the mobile terminal, the print right is invalidated in the server. When the mobile terminal transfers the transmitted print data to the printer, the print data is deleted in the mobile terminal.

### BACKGROUND OF THE INVENTION

1. Field of the Invention

The present invention relates to a print system and a print method, which includes a mobile terminal that is provided to acquire contents for printing, where the contents is being provided on a network, via the mobile terminal.

2. Description of the Related Art

Services and/or print systems configured to acquire contents for printing through a mobile phone, the contents being prepared in a server provided on a network, and connect the mobile phone to a printer so that the acquired contents are printed through the printer have been known, as disclosed in Japanese Patent Laid-Open No. 2002-140254, for example.

Japanese Patent Laid-Open No. 2002-140254 discloses a system that acquires contents prepared in a server through a printer and that performs charging when printing is finished. In the above-described system, a user is charged each time desired contents are printed. However, the user can acquire and print the same contents any number of times. Further, the system allows a contents-service provider to collect the fee for contents each time the contents are printed by the user.

Incidentally, in the above-described system configured to collect the fee, the contents-service provider can permit the printing of the same contents any number of times by performing the charging. On the other hand, for some of contents provided by the contents-service provider, the contents-service provider may wish to limit the number of times the user can print the contents, so as to reduce the duplication of the print of the contents (the contents-service provider may not wish to permit the printing many times). For example, copyrighted contents correspond to the above-described contents. Imposing a print limit is effective to prohibit the duplication of the above-described contents.

However, even though the above-described system disclosed in Japanese Patent Laid-Open No. 2002-140254 allows for limiting the printing of the contents by performing charging in the above-described manner, it is difficult for the system to limit the duplication of the contents.

### SUMMARY OF THE INVENTION

The present invention provides a print system configured to acquire contents for printing provided on a network via a mobile phone and print the contents, so as to reduce the duplication of contents.

The present invention further provides a print system that acquires contents from a server via a mobile terminal and that prints the contents through a printer, includes the mobile terminal that includes a first request unit configured to request the contents from the server, a first acquisition unit configured to acquire right information including a print right, the right information being issued from the server, a second request unit configured to transmit the print right to the server and requests print data corresponding to the print right from the server, a second acquisition unit configured to acquire and store the print data transmitted from the server, and a transfer unit configured to transfer the stored print data to the printer, the server includes an issuing unit configured to issue the right information to the mobile phone based on the contents requested by the first request unit, a determining unit configured to receive the print right transmitted from the second request unit and determine whether the print right is valid, a transmission unit configured to transmit the print data corresponding to the print right when it is determined that the print right is valid by the determining unit, and an invalidation unit configured to invalidate the print right received by the determining unit when the transmission unit transmits the print data, the printer includes a receiving unit configured to receive the print data transferred from the transfer unit, and a print unit configured to print the print data received by the receiving unit, and wherein the mobile terminal deletes the print data stored in the second acquisition unit after the transfer performed by the transfer unit is finished.

Further features and aspects of the present invention will become apparent from the following description of exemplary embodiments with reference to the attached drawings.

### BRIEF DESCRIPTION OF THE DRAWINGS

FIG. 1 shows an exemplary configuration of a system according to a first embodiment of the present invention.

FIG. 2 shows another exemplary configuration of the system.

FIG. 3 is an exemplary block diagram showing the schematic configuration of a printer included in an image-processing system provided in the system.

FIG. 4 is an exemplary block diagram showing the schematic configuration of a mobile phone used in the system.

FIG. 5 is an exemplary block diagram showing the configuration of a right-management server used in the system.

FIG. 6 is an exemplary block diagram showing the configuration of a content server used in the system.

FIG. 7 shows an exemplary configuration of a mobile-phone application operating on the mobile phone.

FIG. 8 shows an exemplary configuration of a printer application operating on the printer.

FIG. 9 is an exemplary sequence diagram illustrating that the right to print contents is acquired by the mobile phone and right information is downloaded.

FIG. 10 is an exemplary sequence diagram illustrating that the mobile phone transfers the right information to the printer.

FIG. 11 is an exemplary sequence diagram illustrating from when the printer downloads print information of the contents corresponding to the right information to when the printer prints the print information.

FIG. 12 is an exemplary sequence diagram illustrating that the mobile phone's own right information is deleted.

FIG. 13 shows an exemplary flow of processing procedures performed by the right-management server when the mobile phone downloads the right information from the right-management server.

FIG. 14 shows an exemplary flow of processing procedures performed by the mobile phone when the mobile phone downloads the right information from the right-management server.

FIG. 15 shows an exemplary flow of processing procedures performed by the mobile phone until the printer stores the right information transmitted from the mobile phone.

FIG. 16 shows an exemplary flow of processing procedures performed by the printer until the printer stores the right information.

FIG. 17 shows an exemplary flow of processing procedures performed by the right-management server until the printer acquires the print information.

FIG. 18 shows an exemplary flow of processing procedures performed by the printer until the printer acquires the print information.

FIG. 19 shows an exemplary configuration of contents according to the first embodiment.

FIG. 20 shows an exemplary flow of processing procedures performed by the right-management server when the right information stored in the mobile phone is deleted.

FIG. 21 shows an exemplary flow of processing procedures performed by the mobile phone when the right information stored in the mobile phone is deleted.

FIG. 22 shows an example of the right information.

FIG. 23 shows an exemplary configuration of data on a preview image.

FIG. 24 shows an example of the print information.

FIG. 25 shows another example of the print information.

FIG. 26 shows an exemplary configuration of print data.

FIG. 27 is an exemplary diagram of a sequence performed when a communication path through which the print information is downloaded is selected.

FIG. 28 shows an example image displayed on the mobile phone when the communication path is selected.

FIG. 29 illustrates an exemplary flow of processing procedures performed to switch between communication paths in the mobile phone based on the communication states of the communication paths.

FIG. 30 illustrates an exemplary flow of processing procedures performed to switch between the communication paths in the mobile phone based on the communication speeds of the communication paths.

FIG. 31 illustrates an exemplary flow of processing procedures performed to change the communication path based on the memory capacity of the mobile phone.

FIG. 32 illustrates an exemplary flow of processing procedures performed to change the communication path based on the memory capacity of the printer.

FIG. 33 illustrates that the mobile phone acquires the right information from the right-management server, and transfers the right information to the printer.

FIG. 34 illustrates an exemplary configuration in which the servers are integrated with each other.

FIG. 35 illustrates an exemplary system configured to download the print information without using a network.

FIG. 36 is an exemplary sequence diagram illustrating from when the mobile phone acquires the right to print the contents to when the mobile phone downloads the right information.

FIG. 37 is an exemplary sequence diagram illustrating that the mobile phone and the printer confirm the printer information, and the print information is downloaded and printed.

FIG. 38 shows an exemplary flow of processing procedures performed by a right-management server used in a system configured to download the print information without using the network.

FIG. 39 shows an exemplary flow of processing procedures performed by a mobile phone used in the system configured to download the print information without using the network.

FIG. 40 shows an exemplary flow of processing procedures performed by a printer used in the system configured to download the print information without using the network.

### DESCRIPTION OF THE EMBODIMENTS

### First Exemplary Embodiment

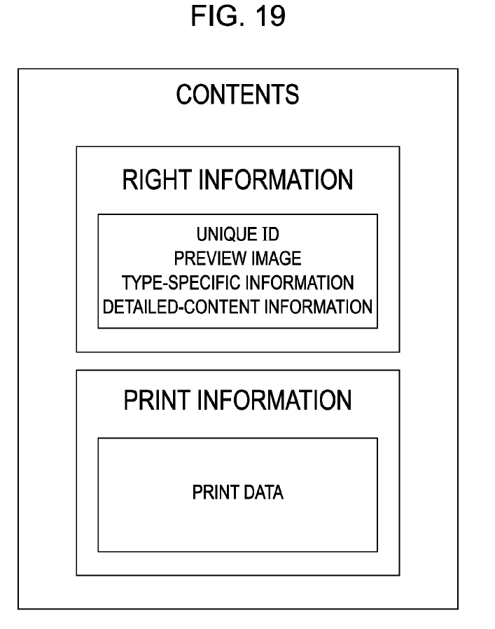

FIG. 19 shows an exemplary configuration of contents according to a first embodiment of the present invention. In FIG. 19, the contents include two items of information, that is, right information and print information. However, the right information and the print information may be separately managed depending on systems achieving the present invention. In embodiments of the present invention, the term “contents” is used as a general term for both the right information and the print information.

The print information includes print data that is existing in a content server and/or a server which is a combination of a right-management server and the content server that are provided on a network and that is data for which a user issues a print request. In the first embodiment, the print data corresponds to image data and/or text data. The print data may be provided in any file format so long as the print data can be printed through a printer.

The right information includes data on a unique ID, data on a preview image, type-specific information, and detailed-content information. The right information is given to the user when the user acquires desired print data, as the right to print data.

The unique ID is issued by the right-management server each time the user selects contents and issues a print request therefore. Then, the unique ID is invalidated after the print information is downloaded from the server. If a plurality of print requests is issued for a single print-information item (print data) existing in the server, unique IDs varying with the print requests are issued.

Due to the above-described unique ID, the right-management server can identify contents, that is, the contents corresponding to the unique ID, and the print information (print data) of the contents.

The preview-image data is image data complying with print information used to confirm contents desired by the user on a mobile phone and/or a printer. The type-specific information indicates the type of a printer that can print the print information and includes information such as data of the manufacturer, the type, the specification version of the printer.

The detailed-content information corresponds to information about the capability of the printer and includes data on the size and type of a sheet, the text code, the resolution of the print data, the size of the print data, and the file format that comply with the print information.

The preview-image data, the type-specific information, and the detailed-content information are stored in the server in relation to the print information.

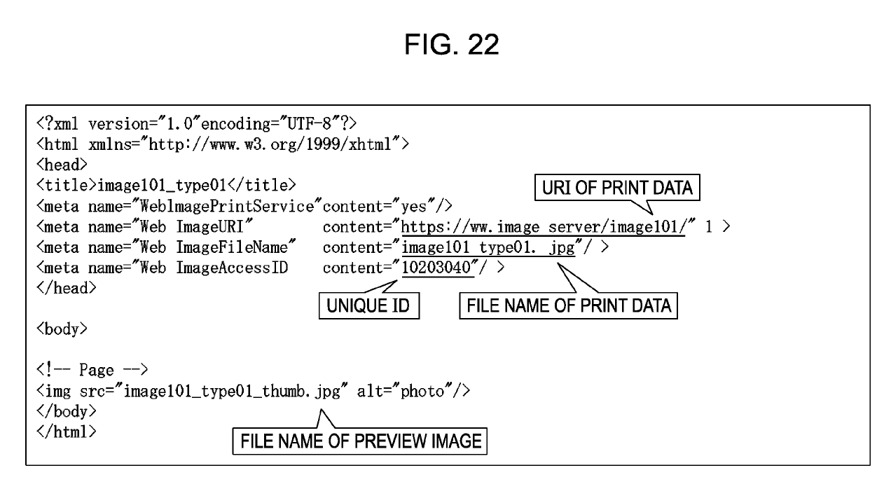

FIG. 22 shows an example of the right information written in an extensible markup language (XML). The right information includes information about the configuration and/or the print data, information about the preview image, and the preview-image data.

Other than information about the version of the XML, the uniform resource identifier (URI), the file name, and the unique ID of the print information, and the file name of the preview image are illustrated in FIG. 22, as the exemplary configuration.

The type-specific information and the detailed-content information are also illustrated, though not shown in FIG. 22.

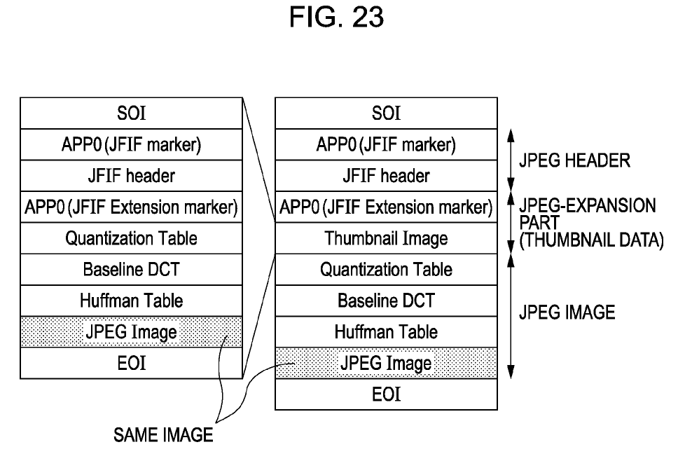

FIG. 23 shows an exemplary data configuration of the preview image. The above-described data configuration is in conformity with the Joint-Photographic-Experts-Group (JPEG) file interchange format (JFIF) system that have been widely available, as an industry-standard format.

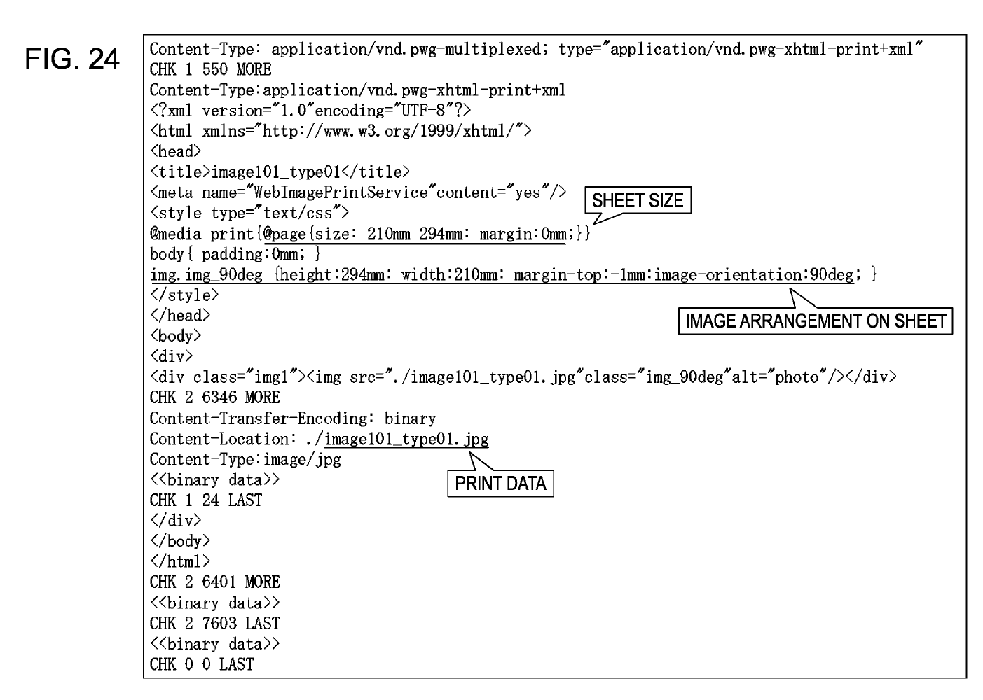

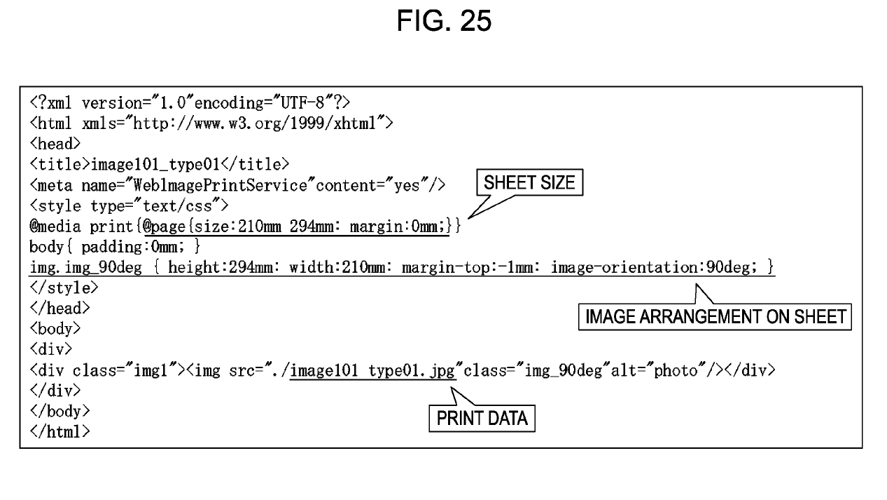

Each of FIGS. 24 and 25 shows an example of the print information written in an Extensible HyperText Markup Language (XHTML)-print. The print information includes data on the size of an output sheet, information about how images are arranged on the sheet, and information about the print data. In FIG. 24, the print data is directly included in the print information, as binary data. On the other hand, in FIG. 25, the print data is received, as data on a separate file based on file-location information written in the print information.

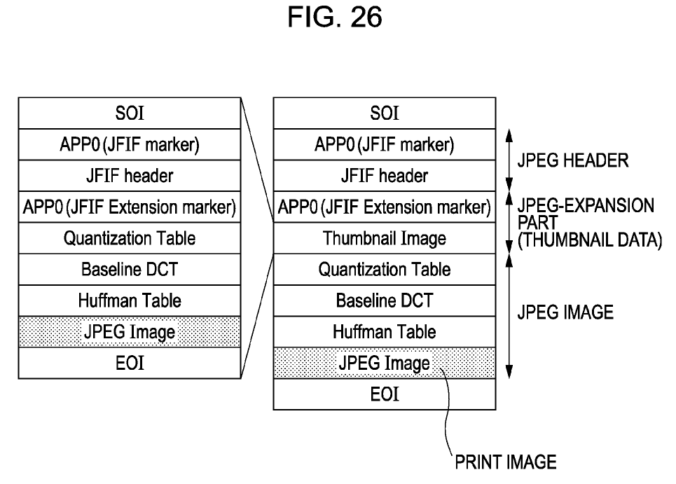

FIG. 26 shows an exemplary configuration of the print data. The data configuration is in conformity with the JFIF system, as is the case with the data configuration of the preview image shown in FIG. 23.

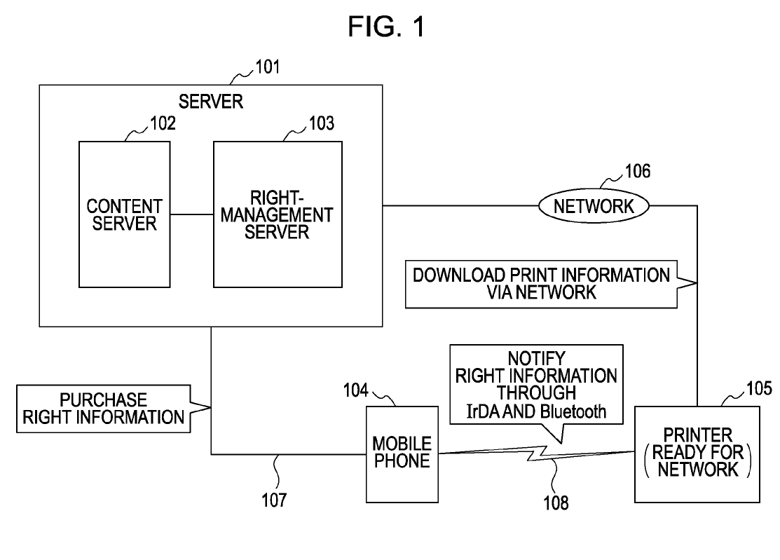

FIG. 1 shows an exemplary configuration of the first embodiment. According to the first embodiment, the user can acquire the right to print printable contents through a mobile terminal such as a mobile phone and print print information included in the contents through a printer. In that case, managing the print charge with precision and managing the right to print the data properly are of importance particularly for managing the copyright on data for printing, etc. Consequently, the right to print contents can be properly managed in the case where data items are exchanged between terminals, as is the case with the first embodiment.

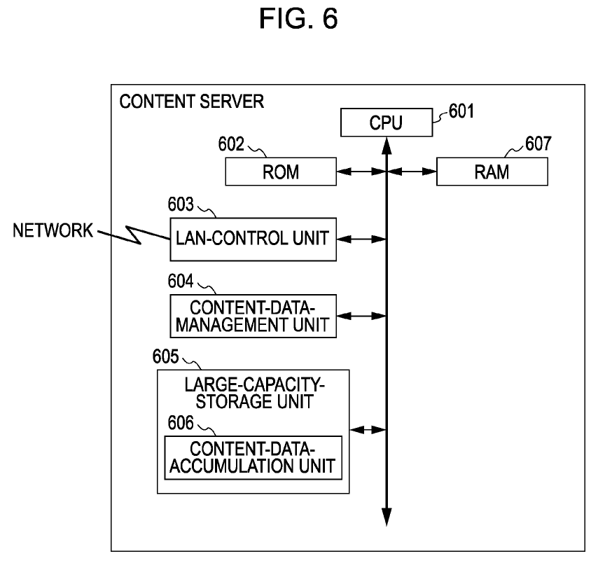

First, a server 101 is provided to perform the data management, etc. according to the first embodiment. Further, two types of servers including a content server 102 and a right-management server 103 are provided in the first embodiment. In the above-described system, the content server 102 stores and manages contents acquired by the user, where details on the content server 102 will be described later with reference to FIG. 6. The right-management server 103 performs data control and/or data management for at least one point consumed by the user, so as to acquire the right to print the contents, and/or the content-print-right acquisition, and management of the site information, for example.

Although the content server 102 and the right-management server 103 are independently provided in FIG. 1, the content server 102 and the right-management server 103 may be provided as a single server. Further, since the effect of providing two servers is the same as that obtained by providing at least two servers, the number of the servers is not limited to the above-described embodiment.

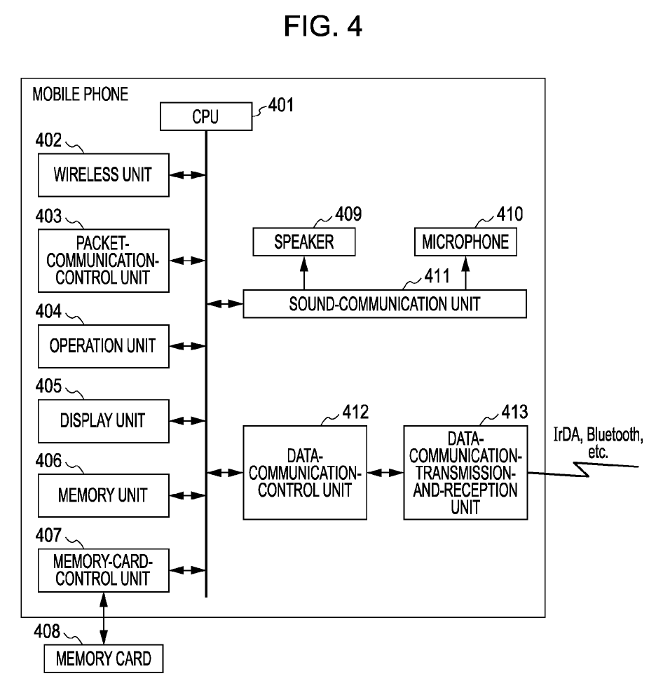

In the above-described configuration, a mobile phone 104 is a terminal operated by the user, so as to acquire the right to print the contents and print the print information. The mobile phone 104 can obtain data from the server 101 via a communication line 107 and transmit data to a printer 105 which will be described later. FIG. 4 is the detailed block diagram of the mobile phone 104.

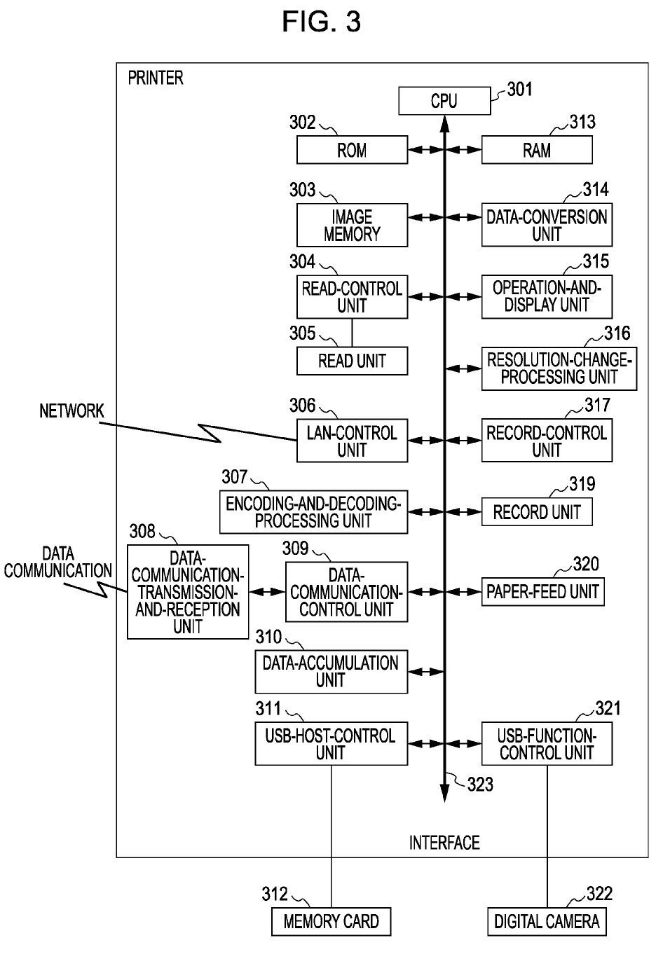

The printer 105 is an image-processing apparatus configured to print the print information of the contents, as will be described with reference to FIG. 3. The printer 105 can wirelessly communicate with the mobile phone 104 through a data communication 108 and connect with the mobile phone 104 by using Infrared Data Association (IrDA) and/or Bluetooth. Further, data communications can be established between the printer 105 and the mobile phone 104 through connections using a cable-communication path such as a Universal Serial Bus (USB) cable. Further, the printer 105 can communicate with the server 101 via a network 106.

In the above-described embodiment, the right information managed by the server 101 can be downloaded to the mobile phone 104 through the configuration shown in FIG. 1. Further, the right information is transferred to the printer 105 via the mobile phone 104. Further, the print information is downloaded from the server 101 to the printer 105 via the network 106 based on the transferred right information and printed. Thus, a print system including the mobile phone 104 and the printer 105 is constructed.

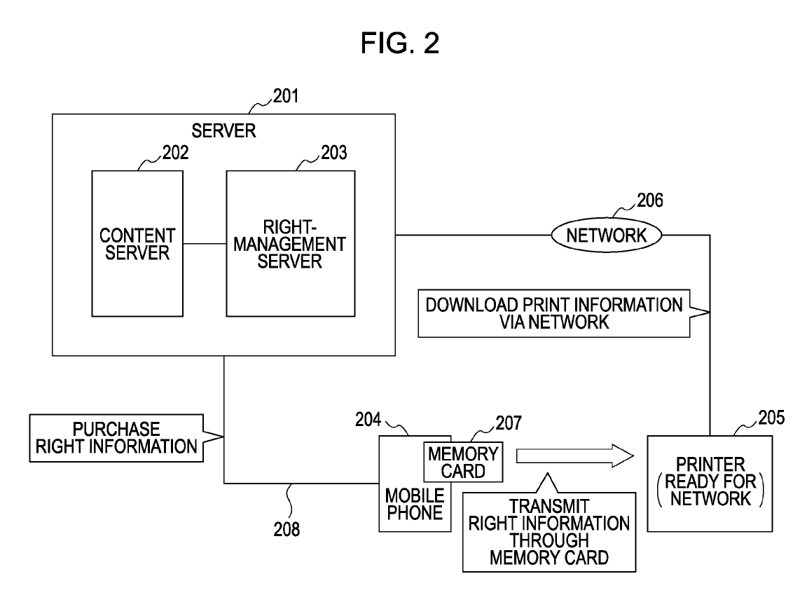

FIG. 2 shows an exemplary configuration of the above-described print system, which is the same as that shown in FIG. 1 except for the omission of the data communication 108.

First, a server 201 is provided to perform the data management, etc. according to the first embodiment. In FIG. 2, two types of servers including a content server 202 and a right-management server 203 are also provided. In the above-described system, the content server 202 stores and manages contents acquired by the user, where details on the content server 202 will be described later with reference to FIG. 6. The right-management server 203 performs data control and/or data management for at least one point consumed by the user, so as to acquire the right to print the contents, and/or the content-print-right acquisition, and management of the site information, for example.

Although the content server 202 and the right-management server 203 are independently provided in FIG. 2, the content server 202 and the right-management server 203 may be provided as a single server. Further, since the effect of providing two servers is the same as that obtained by providing at least two servers, the number of the servers is not limited to the above-described embodiment.

In the above-described configuration, a mobile phone 204 is a terminal operated by the user, so as to acquire the right to print the contents and print the print information. The mobile phone 204 can obtain data from the server 201 via a communication line 208. Further, a memory card 207 can be inserted into the mobile phone 204 so that data on the mobile phone 204 can be written and stored in the memory card 207. FIG. 4 is an exemplary detailed block diagram of the mobile phone 204.

The printer 205 is an image-processing apparatus configured to print the print information of the contents, as will be described with reference to FIG. 3. As for the characteristics, the memory card 207 can be inserted into the printer 205 so that the printer 205 can read and/or store data stored in the memory card 207, and/or write and/or store data in the memory card 207. Further, the printer 205 can communicate with the server 201 via a network 206.

In the above-described embodiment, the right information managed by the server 201 can be downloaded to the mobile phone 204 through the configuration shown in FIG. 2. The right information is transferred from the mobile phone 204 via the memory card 207 and stored in the printer 205. Further, the print information is downloaded from the server 201 to the printer 205 via the network 206 based on the right information read from the memory card 207 and printed. Thus, a print system including the mobile phone 204 and the printer 205 is constructed.

Each of FIGS. 1 and 2 is independently described for the sake of convenience. According to the first embodiment, however, both FIGS. 1 and 2 are provided to illustrate the terminals, as configurations which can be actualized.

FIG. 3 is a block diagram showing the schematic configuration of a printer included in an image-processing system according to the first embodiment.

In the printer, a central-processing unit (CPU) 301 is provided as a system-control unit controlling the printer.

A read-only memory (ROM) 302 stores programs such as a control program, a pre-installed operating system (OS) program, that are executed by the CPU 301. According to the first embodiment, each of the control programs stored in the ROM 302 performs software control including scheduling, task switching and the like under the control of the pre-installed OS program stored in the ROM 302.

An image memory 303 includes memories such as a dynamic random-access memory that accumulates image data. Further, downloaded right information and/or print information are also stored in the image memory 303.

A read-control unit 304 will be described. A read unit 305 optically reads data on a document through a contact image sensor (CIS). Next, an image signal converted into electrical image data is subjected to image processing of various types, for example, binarization processing, halftone processing, via an image-processing-control unit (not shown) so that high-precision image data is output. In the first embodiment, the read-control unit 304 is ready for both a sheet-read-control system appropriate to read data while carrying a document and a book-read-control system provided to scan data on a document placed on a document plate.

A local-area-network (LAN)-control unit 306 is configured to perform control when establishing connections through a network. An encoding-and-decoding-processing unit 307 performs encoding-and-decoding processing and/or enlarging-and-reducing processing for image data (compressed by the Modified Huffman (MH) method, the Modified READ (MR) method, the Modified Modified READ (MMR) method, the Joint Bi-level Image Experts Group (JBIG) method, the JPEG method, etc.) handled by the printer.

A data-communication-transmission-and-reception unit 308 is provided as a unit configured to transmit and receive data, so as to communicate with a device such as a mobile phone through wireless communications including the IrDA communications, the Bluetooth communications, etc. The transmission-and-reception unit may be provided for each data communication. According to the first embodiment, connections are established by using IrDA, Bluetooth, PictBridge, etc.

A data-communication-control unit 309 is a unit configured to control data transmitted from the data-communication-transmission-and-reception unit 308. Data can be transmitted through wireless connections established through IrDA, Bluetooth, etc. and/or connections established through PictBridge by using the data-communication-control unit 309 and the data-communication-transmission-and-reception unit 308.

A data-accumulation unit 310 is a unit configured to accumulate data. Since no data-back-up area is prepared in the DRAM of the image memory 303, a data-storage area is prepared as the data-accumulation unit according to the first embodiment. The data-storage area may be shared with the image memory 303. Data can be backed up to the data-accumulation unit 310, for example. Although the DRAM is used in the first embodiment, a hard disk, a volatile memory, etc. may be used without being limited to the above-described configuration.

A USB-host-control unit 311 is configured to perform communications under a protocol determined based on the USB-communications standards. The USB-communications standards allow for performing bidirectional data communications with high speed so that a plurality of hubs and/or functions (slaves) can be connected to a single host (master).

A memory card 312 is a detachable data-storage medium which can be inserted into the printer through a memory slot (not shown) in which a memory card can be inserted. In the first embodiment, the memory card 312 is connected to the USB-host-control unit 311 through an interface, the connection may be established without being limited to the above-described embodiment. The right information and/or the print information can be stored in the memory card 312. The above-described data stored in the memory card 312 can be accessed through the USB-host-control unit 311.

A RAM 313 including a static RAM (SRAM), etc. stores data on a program-control variable or the like, data on a set value registered by an operator, data on the printer management, etc., and is provided with buffer areas used for various types of works.

A data-conversion unit 314 performs the image-data conversion including the analysis of a page-description language (PDL) or the like, the expansion of the computer graphics (CG) of character data, the expansion of XML data, rendering a vector font, etc.

An operation-and-display unit 315 includes a home key, a navigation key, the Enter key, the Return key, etc. and functions as an operation unit allowing the user to determine image-print data and/or perform registration operations, so as to set a registration value. Further, the operation-and-display unit 315 includes various types of keys, a light-emitting diode (LED), a liquid-crystal display (LCD), etc. Consequently, the operator can perform various types of input operations and/or display the operation conditions and the status conditions of the printer, for example.

A resolution-change-processing unit 316 performs resolution-change control such as changing the millimeter-inch resolution of image data. Further, the resolution-change-processing unit 316 can enlarge and reduce the image data.

A record-control unit 317 performs image processing of various types, that is, smoothing processing, record-density-correction processing, color correction, etc. for image data for printing via an image-processing-control unit (not shown) so that the image data is converted into high-precision image data, and outputs the high-precision image data to a record unit 319 which will be described later. Further, the record-control unit 317 controls the record unit 319, whereby information about the state of the record unit 319 is regularly acquired.

In the record unit 319, color-image data and/or monochrome-image data is printed on a printing material.

A paper-feed unit 320 is configured to keep sheets for printing. Paper can be fed from the paper-feed unit 320 under the control of the record-control unit 317. Particularly, a plurality of the paper-feed units can be provided, so as to keep at least two types of sheets in a single apparatus. Then, the record-control unit 317 can perform control, so as to determine which of the paper-feed units should be used to perform the paper feeding.

A USB-function-control unit 321 controls communications performed by a USB interface. Protocol control is performed based on the USB communications standards, data obtained through a USB-control task executed by the CPU 301 is converted into packet data, and the packet data is transmitted to an external information-processing terminal, that is to say, USB-packet transmission is performed. On the other hand, a USB packet transmitted from the external information-processing terminal is converted into data and the data is transmitted to the CPU 301, for example. A digital camera 322 is an external information-processing terminal and communicates with the printer via the USB-function-control unit 321.

In the first embodiment, USB communications performed as a record function use a one-to-one-connection configuration.

The above-described components 301 to 311 and 313 to 321 are connected to one another via a CPU bus 323 managed by the CPU 301.

In the first embodiment, data on a text document can be read by the read unit 305 and the read-control unit 304, transmitted through the resolution-change-processing unit 316 and/or the data-conversion unit 314, and stored in the data-accumulation unit 310. Then, the operation-and-display unit 315 is operated so that a search for the text can be made based on data on the operation, the data being transmitted from the operation-and-display unit 315. Here, text data used in the first embodiment may not be limited to the text data obtained through the above-described method. Namely, any text data which is stored in the data-accumulation unit 310 and which includes page information, such as the data transferred from the memory card 312 and the data transmitted through the data-communication-control unit 309, may be used in the first embodiment.

FIG. 4 is an exemplary block diagram showing the schematic configuration of a mobile phone included in the system according to the first embodiment. In the mobile phone, a CPU 401 is provided as a system-control unit controlling the mobile phone. A wireless unit 402 is provided to transmit and receive communication data, so as to perform wireless communications through the mobile phone.

A packet-communication-control unit 403 is a block performing control when packet communication is performed, where the packet communication is one type of communication using the wireless unit 402. According to the first embodiment, data on a mobile site, data used for printing, etc. are downloaded during packet communication performed by the mobile phone.

An operation unit 404 is a block provided to operate the mobile phone. Numeric keys, function keys, a menu key, vertical and horizontal keys, etc. are mounted on the operation unit 404. Therefore, it becomes possible to perform operations through the mobile phone, so as to achieve not only conversations, but also wireless communication performed through the packet communication and/or communications including the IrDA communications, the Bluetooth communications, etc.

A display unit 405 displays information about the mobile phone. The display of phone numbers, the selection of data used for data communication, the display of a mobile site, and so forth are performed on the screen of the display unit 405. Further, image data stored in a memory card 408 can also be displayed on the screen, for example.

A memory unit 406 stores data on the mobile phone. The program of the mobile phone, data on an image, etc., data on an application, etc. are stored in the memory unit 406. Further, the downloaded right information and/or the downloaded print information is stored in the memory unit 406.

A memory-card-control unit 407 is a block provided to control the memory card 408 that can be detached from the mobile phone. The memory-card-control unit 407 reads data stored in the memory card, writes data in the memory card, performs access control, etc. Incidentally, the memory card 408 can store the right information and the print information.

A speaker 409 and a microphone 410 are mainly used to perform sound communications through a telephone. A sound is picked up from the microphone 410 and output through the speaker 409. The sound communication is controlled by a sound-communication unit 411.

Communications including the IrDA communications, the Bluetooth communications, etc. can be performed through a data-communication-control unit 412 and a data-communication-transmission-and-reception unit 413. The data-communication-control unit 412 is configured to control data and the data-communication-transmission-and-reception unit 413 is configured to transmit and receive data. In the first embodiment, wireless communications including the IrDA communications, the Bluetooth communications, etc. and the PictBridge communications, etc. are performed.

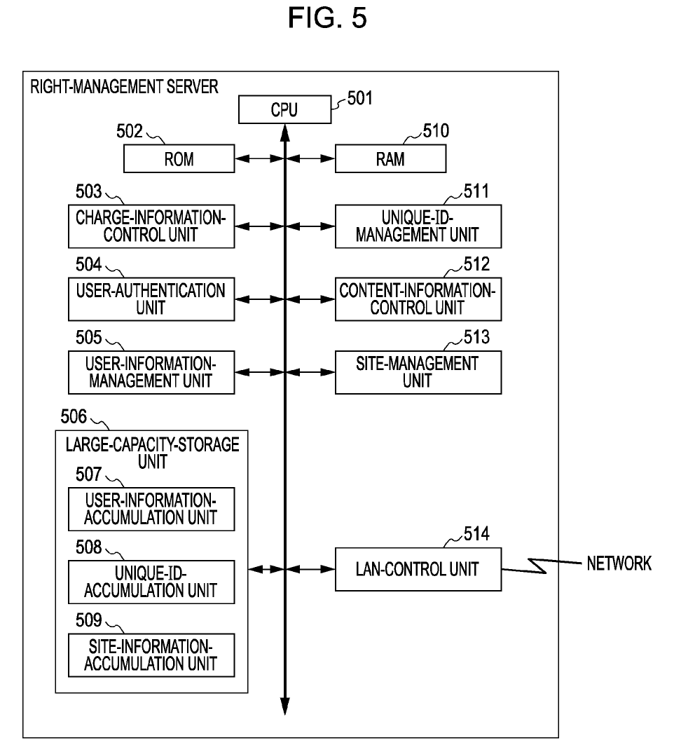

FIG. 5 shows a right-management server according to the first embodiment. Details on each of the right-management servers 203 and 103 that have been described in FIGS. 1 and 2 will be described.

In the right-management server, a CPU 501 is provided as a system-control unit configured to control the right-management server. A ROM 502 stores data or the like necessary for the CPU 501 to perform processing.

A charge-information-control unit 503 is configured to control information used to charge the user the fee for acquiring the right to print contents according to the first embodiment. The user can download the right information of desired contents for printing and further download print information according to a method that will be described later. Here, information about charging occurring due to the above-described processing is controlled.

A user-authentication unit 504 is a block configured to authenticate users. In the first embodiment, the user authentication is performed upon receiving a request for the right information from the mobile phone, so as to authenticate a user who issued the request. The user authentication is performed under the control of the above-described block.

A user-information-management unit 505 is a block configured to manage user information that is transmitted from the mobile phone and that is accumulated in a user-information-accumulation unit 507 that will be described later.

A large-capacity-storage unit 506 is configured to store data on the right-management server, and is configured to store a control program, an OS program, etc. that are executed by the CPU 501. In the first embodiment, individual control programs stored in the large-capacity-storage unit 506 perform software control including scheduling, the task switching, etc. under the control of the OS program stored in the large-capacity-storage unit 506. Further, the user-information-accumulation unit 507, a unique-ID-accumulation unit 508, a site-information-accumulation unit 509, etc. are also stored in the large-capacity-storage unit 506.

The user-information-accumulation unit 507 stores information such as user information obtained from the mobile phone, information about the history of contents for which the print right is acquired, information about the user's points (indicating the remaining points of each user), etc.

Information about a unique ID given for each print right of the contents is accumulated in the unique-ID-accumulation unit 508. Information about a user who acquires the right to print the contents corresponding to each unique ID and information indicating whether the download of the print information corresponding to the contents is completed are also accumulated in the unique-ID-accumulation unit 508.

When the mobile site is accessed by the mobile phone, information about a site used by the user to find the contents is accumulated in the site-information-accumulation unit 509.

A RAM 510 includes, for example, an SRAM, etc., that stores data on a program-control variable or the like, data on a set value registered by the operator, data on the printer management, etc., and is provided with buffer areas used for various types of works.

A unique-ID-management unit 511 is a block provided to generate the unique ID and manage data accumulated in the unique-ID-accumulation unit 508. The unique-ID-management unit 511 transmits and/or receives information to and/or from the content server and/or the mobile phone, and manages necessary information, for example.

A content-information-control unit 512 is a block provided to control information relating to the contents. The content-information-control unit 512 controls information which is not managed by the unique-ID-management unit 511 and information about other contents.

A site-management unit 513 is a block provided to manage a site. The site can be accessed by a mobile phone or the like. The site-management unit 513 manages information about the site-information-accumulation unit 509 provided in the large-capacity-storage unit 506.

A LAN-control unit 514 is provided to perform LAN control so that the right-management server can be connected to a network, which allows the right-management server to connect with the network.

FIG. 6 is a content server according to the first embodiment. Details on each of the content servers 102 and 202 that have been described in FIGS. 1 and 2 will be described.

In the content server, a CPU 601 is provided as a system-control unit configured to control the content server. A ROM 602 stores data or the like necessary for the CPU 601 to perform processing.

A LAN-control unit 603 performs the LAN control so that the right-management server can be connected to the network. The LAN control allows the right-management server to connect with the network.

A content-data-management unit 604 is a block provided to manage data accumulated in a content-data-accumulation unit 606 provided in a large-capacity-storage unit 605.

The large-capacity-storage unit 605, which is provided to store data on the content server, stores a control program, an OS program, etc. that are executed by the CPU 601. According to the first embodiment, individual control programs stored in the large-capacity-storage unit 605 perform the software control including the scheduling, the task switching, etc. under the control of the OS program stored in the large-capacity-storage unit 605.

The content-data-accumulation unit 606 accumulates contents which are not yet provided with the unique ID, where the contents include data on a preview image which will be described later, type-specific information, detailed-content information, and print data.

A RAM 607 includes an SRAM, etc. stores data on a program-control variable or the like, data on a set value registered by the operator, data on the printer management, etc., and is provided with buffer areas used for various types of works.

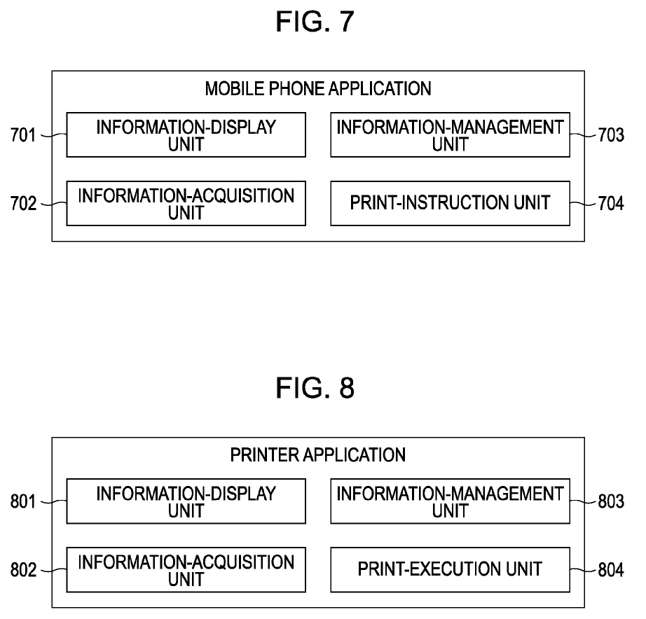

FIG. 7 shows a mobile-phone application operating on the mobile phone according to the first embodiment. The mobile-phone application can operate on each of the mobile phones 104 and 204. Particularly, the mobile-phone application is used to acquire information from the mobile phones 104 and 204, and/or the right-management servers 103 and 203 in the first embodiment. Further, information is transmitted to each of the printers 105 and 205 through the above-described mobile-phone application.

An information-display unit 701 displays data acquired from the right-management server shown in FIG. 5 by the mobile phone shown in FIG. 4. The remaining points of the user, information about points of the contents, potential contents, a preview image on which data is included in the right information of acquired contents, etc. are displayed by the information-display unit 701.

An information-acquisition unit 702 is a block provided to acquire contents from the right-management server. Particularly, the information-acquisition unit 702 controls transmission and/or reception of data, such as transmission of acquisition-completion information to the right-management server, where the acquisition-completion information is obtained at the content-acquisition time.

An information-management unit 703 is a block managing information about the acquired contents. Information about the contents, such as the right information and/or the print information of the contents is controlled by the above-described block. The right information and the print information will be described later. The information-management unit 703 deletes the content information when the content information becomes unnecessary.

A print-instruction unit 704 is a block provided to instruct the printer to print the contents. In the first embodiment, not only giving the print instruction, but also the transfer of the print information to the printer and writing the right information into the memory card 207 are performed.

FIG. 8 shows a printer application operating on the printer according to the first embodiment. The printer application can operate on each of the printers 105 and 205. Particularly, the printer application is used to acquire information from the printers 105 and 205, and/or the right-management servers 103 and 203 according to the first embodiment. Further, information is transmitted to each of the printers 105 and 205 through the above-described printer application.

An information-display unit 801 displays a preview image, where data on the preview image is included in the right information acquired from the mobile phone by the printer shown in FIG. 1.

An information-acquisition unit 802 is a block provided to acquire contents from the mobile phone and/or the right-management server. Particularly, the information-acquisition unit 802 controls transmission and/or reception of data, such as transmission of acquisition-completion information to the server, where the acquisition-completion information is obtained at the content-acquisition time. Further, the right information is also acquired from the memory card 207 through the above-described block.

An information-management unit 803 is a block provided to manage information about the acquired contents. Information about the contents, such as the right information and/or the print information of the contents is managed by the above-described block. The deletion of information relating to the contents is also performed by the information-management unit 803.

A print-execution unit 804 is a block provided to execute printing of the contents.

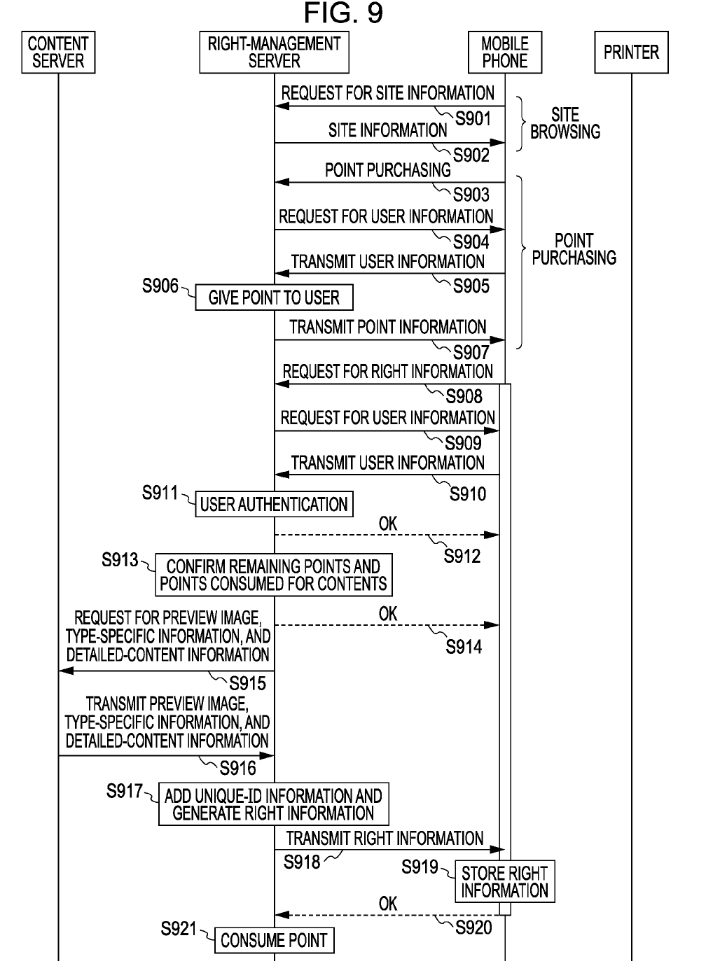

FIG. 9 is an exemplary sequence diagram illustrating from when a site is browsed and the right to print the contents is acquired through the mobile phone to when the right information is downloaded.

The sequence of processing procedures performed among the content server, the right-management server, the mobile phone, and the printer will be described.

The mobile phone requests the right-management server to transmit the site information at step S901. The right-management server transmits the site information to the mobile phone in response to the request at step S902. Consequently, it becomes possible to browse the site information through the mobile phone. Thus, in the first embodiment, it becomes possible to select contents for printing and/or purchase a point to acquire the right to print the contents by browsing the site through the mobile phone. Next, the sequence of processing procedures performed to purchase a point will be described.

The mobile phone transmits a request to purchase the point to the right-management server at step S903. Upon receiving the point-purchase request, the right-management server issues a request for information about the user of the mobile phone at step S904. Upon receiving the user-information request, the mobile phone transmits the user information to the right-management server at step S905.

Upon receiving the user information, the right-management server gives the point to the user of the mobile phone in step S906, and transmits information about the point to the mobile phone in step S907. The reception of the point information allows the user of the mobile phone to purchase the right to print the contents.

The user who had purchased the point should obtain the right information, so as to acquire the right to print desired contents and print the contents. Therefore, a request for the right information is transmitted to the right-management server at step S908. The right-management server authenticates the user to issue the right information. Therefore, the right-management server makes a request for the user information at step S909. The user information is transmitted from the mobile phone in response to the request at step S910.

Upon receiving the user information, the right-management server executes the user authentication for verification in step S911. After the user is confirmed, the right-management server informs the mobile phone of the confirmation at step S912. Further, the right-management server confirms the remains of the points given to the user and consumed points necessary to acquire the right to print the contents in step S913, and informs the mobile phone of the confirmation result at step S914. Subsequently, the right-management server requests the content server to transmit the preview-image data, the type-specific information, and the detailed-content information in step S915, so as to generate the right information. The content server transmits the requested information to the right-management server at step S916. The right-management server generates the unique ID by which the unique-ID-management unit 511 uniquely identifies the print right, and generates the right information including the transmitted information and the generated unique ID in step S917.

The generated right information is transmitted to the mobile phone in step S918. Upon receiving the right information requested at step S908, the mobile phone stores the right information in the memory unit 406 of the mobile phone at step S919. After the right information is stored, the mobile phone informs the right-management server of the reception of the right information at step S920. Upon receiving the notification that the right information is received from the mobile phone, the right-management server consumes at least one point of the points that had been given to the user in step S921, the at least one point being necessary to acquire the right to print the contents, at step S906.

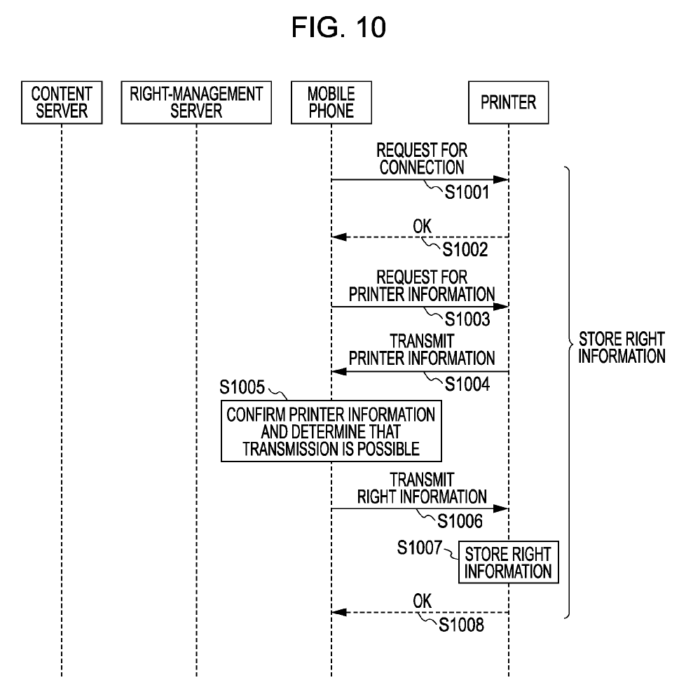

FIG. 10 is an exemplary sequence diagram illustrating that the right information including the unique ID is downloaded from the right-management server to the mobile phone, as shown in FIG. 9, and the user transfers the right information to the printer at arbitrary time.

The user transmits the print information corresponding to the downloaded right information from the mobile phone to the printer by performing data communications based on IrDA, Bluetooth, etc. so that the transfer of the right information is achieved.

The mobile phone requests the printer to establish a connection at step S1001. Upon receiving the request for the connection, the printer responds to the request, as OK, at step S1002. When the connection is established, the mobile phone issues a request for the printer information owned by the printer at step S1003, and the printer transfers the printer information of its own to the mobile phone in response to the request at step S1004. Here, the printer information includes information such as data on the name of the manufacturer, the type name, the specification version, the size and/or the type of a compatible sheet, and the character font of the printer. The printer information also includes information about the status of the printer at the connection-request time. The status information includes data on the error state, the remaining sheets, the amount of remaining ink and/or toner, and the network-active state of the printer.

The mobile phone confirms and compares the printer information transmitted at step S1004 to the right information stored in the mobile phone, and determines whether the print information can be printed through the printer at step S1005. If it is determined that the print information can be printed, the right information is transmitted to the printer at step S1006.

The printer stores the transmitted right information in the image memory 303 of the printer at step S1007, and informs the mobile phone of the reception of the right information at step S1008.

By performing the above-described processing, the right information including the unique ID is stored in the printer, and the printer can download and print the print information of the contents based on the above-described stored right information.

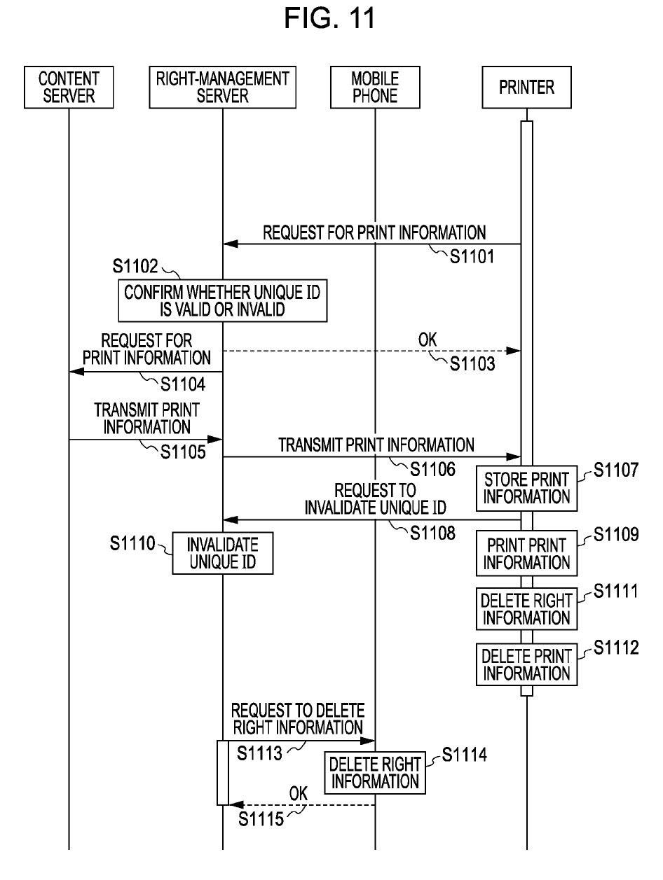

FIG. 11 is an exemplary sequence diagram illustrating processing procedures performed so that the print information of the contents corresponding to the right information is downloaded and printed by the printer based on the right information acquired from the mobile phone.

First, the printer issues a request for the print information to the right-management server via the network at step S1101. Of the right information transmitted from the mobile phone to the printer at step S1006 shown in FIG. 10, at least the unique ID is included in the print-information request. The right-management server manages associating the unique ID with the print information.

Upon receiving the print-information request, the right-management server determines the validity of the unique ID at step S1102.

If the unique ID is valid, the right-management server informs the printer of the validity at step S1103 and issues the print-information request to the content server storing the print information at step S1104.

The content server presents the print information based on the request transmitted from the right-management server at step S1105.

The right-management server transfers the print information transmitted from the content server to the printer via the network at step S1106.

The printer stores the transferred print information in the image memory 303 of the printer in step S1107 and prints the transferred print information at predetermined time at step S1109. After the printing is finished, the right information owned by the printer is deleted at step S1111 and the print information is deleted at step S1112. Before deleting the right information at step S1111, the printer requests the right-management server to invalidate the unique ID owned by the printer at step S1108. The right-management server invalidates the unique ID corresponding to the print information requested by the printer in response to the invalidation request at step S1110.

Further, as described in FIG. 10, the right-management server requests the mobile phone having the transferred right information to delete the right information at step S1113. Upon receiving the deletion request, the mobile phone deletes the right information stored therein at step S1114 and informs the right-management server of the deletion at step S1115.

Further, at step S1101, the print-information request may be issued in response to the user operating the operation-and-display unit of the printer and/or automatically issued in response to the printer acquiring the right information.

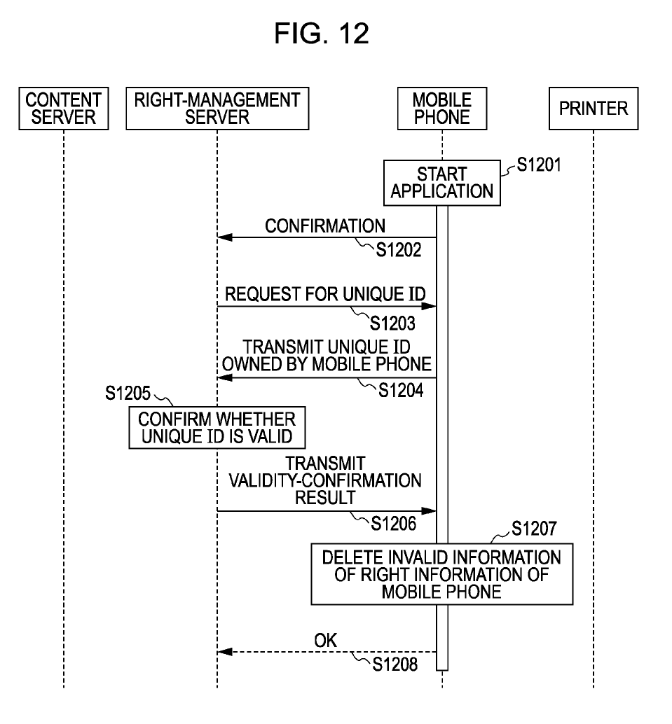

FIG. 12 is an exemplary sequence diagram illustrating that the right information owned by the mobile phone is deleted. At step S1114 shown in FIG. 11, the right information is deleted from the mobile phone based on a request transmitted from the right-management server. However, the right-management server 103 is not necessarily capable of connecting with the mobile phone 104 at that time. Therefore, FIG. 12 illustrates an exemplary sequence of processing procedures performed so that the right information is deleted according as the mobile-phone application is started based on an operation performed by the user.

When the mobile-phone application is started on the mobile phone at step S1201, the mobile phone requests the right-management server to confirm the right information, so as to delete the right-management information at step S1202. Upon receiving the right-information-confirmation request, the right-management server issues a request for the unique ID owned by the mobile phone at step S1203.

The mobile phone transmits the unique ID owned by the mobile phone to the right-management server in response to the unique-ID request transmitted from the right-management server at step S1204.

The right-management server confirms the validity of the received unique ID based on the unique ID transmitted from the mobile phone at step S1205 and transmits data on the confirmation result to the mobile phone at step S1206.

If the transmitted confirmation-result data indicates that invalid right information exists, the mobile phone deletes the invalid right information at step S1207.

If the mobile phone has a plurality of unique IDs, the mobile phone may transmit the unique IDs at step S1204. At that time, the right-management server confirms the validity of each of right-information items transmitted at step S1205. Accordingly, the mobile phone can delete the right-information items at step S1207.

On the other hand, if the mobile phone has a plurality of right-information items, the sequence may be arranged so that the right-information items are confirmed one after another.

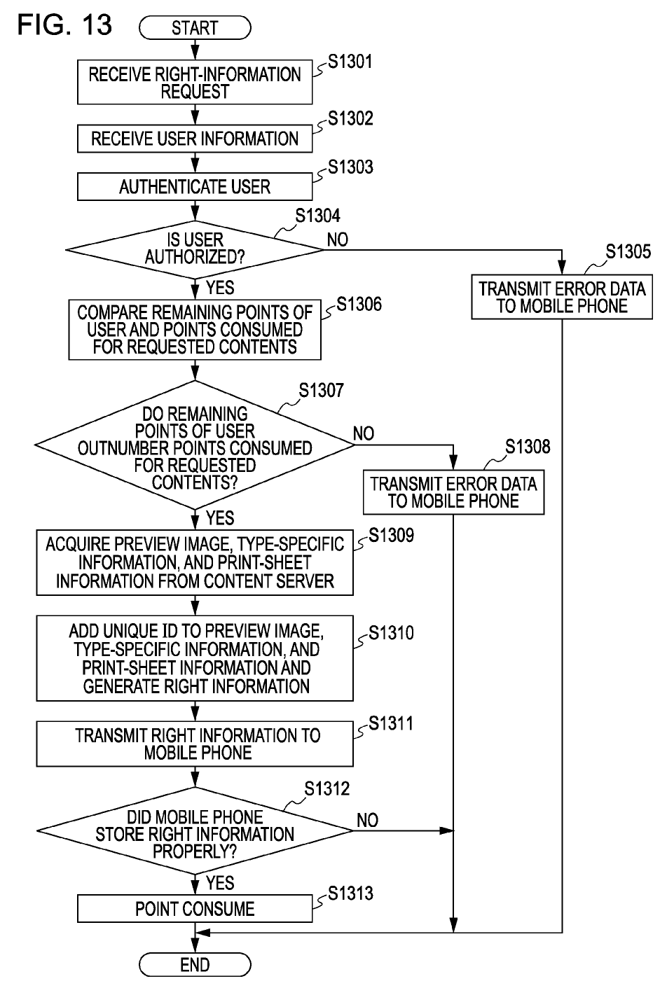

FIG. 13 shows an exemplary flow of processing procedures performed by the CPU 501 of the right-management server 103 when the mobile phone 104 downloads the right information from the right-management server 103.

First, the mobile phone 104 issues a request for the right information to the right-management server 103 at step S1301.

Next, the right-management server 103 requests the mobile phone 104 to transmit the user information, and receives the user information transmitted from the mobile phone 104, as a response to the request at step S1302.

The CPU 501 of the right-management server receives the request for the right information, the request being transmitted from the mobile phone 104 via the LAN-control unit 514, at step S1301. Upon receiving the right-information request, the CPU 501 issues a request for the user information and receives the user information transferred from the mobile phone, as a response to the request at step S1303.

For the received user information, the user-authentication unit 504 performs the user authentication based on the information accumulated in the user-information-accumulation unit 507 at step S1303. If the received user information is accumulated in the user-information-accumulation unit 507 at that time, the user of the mobile phone which had requested the right information is determined to be an authorized user.

If the result of the user authentication shows that the user is not authorized at step S1304 (NO in step S1304), data on an error is transmitted to the mobile phone 104 at step S1305 and the processing is finished.

If the result of the user authentication shows that the user is authorized at step S1304 (YES in step S1304), the CPU 501 compares the remaining points of the authorized user to at least one point consumed for requested contents at step S1306.

As a result of the comparison, the number of the remaining points of the user may be lower than that of the at least one point consumed for the requested contents at step S1307 (NO in step S1307). In that case, error data is transmitted to the mobile phone 104 at step S1308 and the processing is finished at step S1308.

As a result of the comparison, the number of the remaining points of the user may be higher than that of the at least one point consumed for the requested contents at step S1307 (YES in step S1307). In that case, first, the CPU 501 performs control so that the right-management server 103 accesses the content server 102. Then, the CPU 501 acquires detailed information about the requested contents, where the content-detailed information includes data on a preview image, type-specific information, information about a print sheet, etc., and accumulates the detailed content information in the RAM 510 at step S1309.

Next, the CPU 501 performs control so that data on a unique ID is added to the preview-image data, the type-specific information, and the print-sheet information that correspond to the requested contents so that right information is generated at step S1310, and the right information is transmitted to the mobile phone 104 at step S1311.

If it is confirmed that the right information is properly stored in the mobile phone 104 at step S1312 (YES in step S1312), the CPU 501 performs control so that at least one point that should be consumed for purchased contents is consumed from the remaining points of the user and information stored in the user-information-management unit 505 is updated at step S1313. On the other hand, if the right information is not properly stored at step S1312 (NO in step S1312), the processing is suspended and finished.

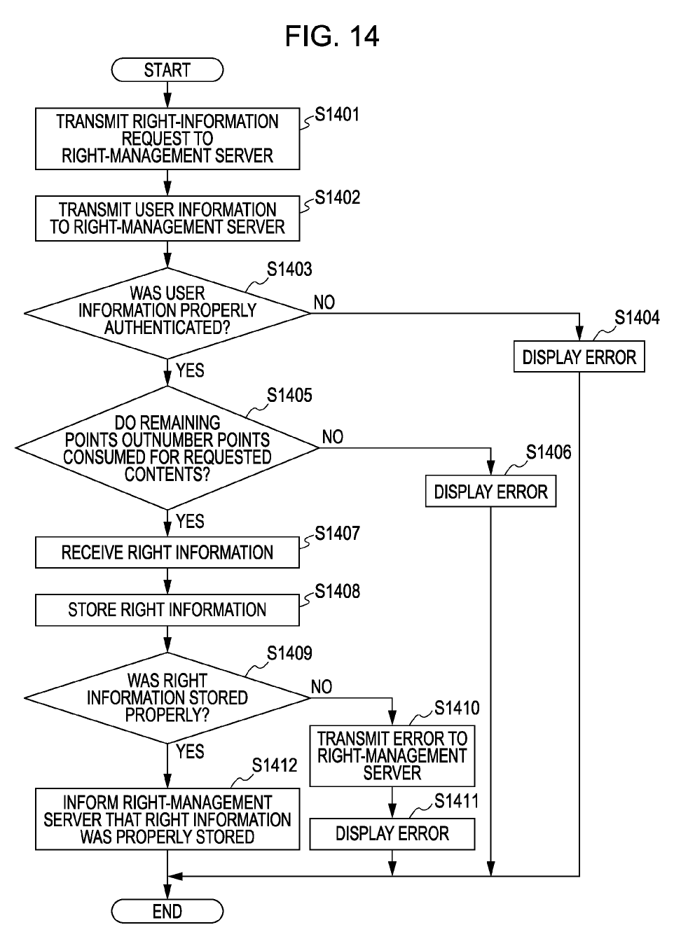

FIG. 14 shows an exemplary flow of processing procedures performed by the CPU 401 of the mobile phone 104 when the mobile phone 104 downloads the right information from the right-management server 103.

First, the CPU 401 of the mobile phone 104 accesses the right-management server 103 and performs control so that a request for the right information is transmitted to the right-management server at step S1401.

Next, the CPU 401 transmits the user information from the mobile phone 104 to the right-management server 103 at step S1402.

If the transmitted user information is not properly authenticated at step S1403 (NO in step S1403), the CPU 401 makes the display unit 405 of the mobile phone 104 display an error at step S1404 and terminates the processing.

If the transmitted user information is properly authenticated (YES in step S1403), the processing advances to the next step, that is, step S1405. The right-management server 103 compares the remaining points of the user to the at least one point consumed for the requested contents at step S1405. If the number of the remaining points is lower than that of the at least one point consumed for the requested contents (NO in step S1405), the right-management server 103 informs the CPU 104 of an error. Therefore, the CPU 104 makes the display unit 405 of the mobile phone 104 display the error at step S1406.

If the number of the remaining points is higher than that of the at least one point consumed for the requested contents at step S1405 (YES in step S1405), the right information is transmitted from the right-management server 103 to the mobile phone 104 at step S1407.

Next, the mobile phone 104 stores the transmitted right information in the memory unit 406 of the mobile phone 104 at step S1408. If it is determined that the right information is properly stored at step S1409 (YES in step S1409), the mobile phone 104 informs the right-management server 103 that the right information is properly stored at step S1412 and terminates the processing.

If it is determined that the right information is not stored properly at step S1409 (NO in step S1409), data on an error is transmitted to the right-management server 103 at step 1410, and the display unit 406 of the mobile phone 104 is made to display the error at step S1411 and the processing is terminated.

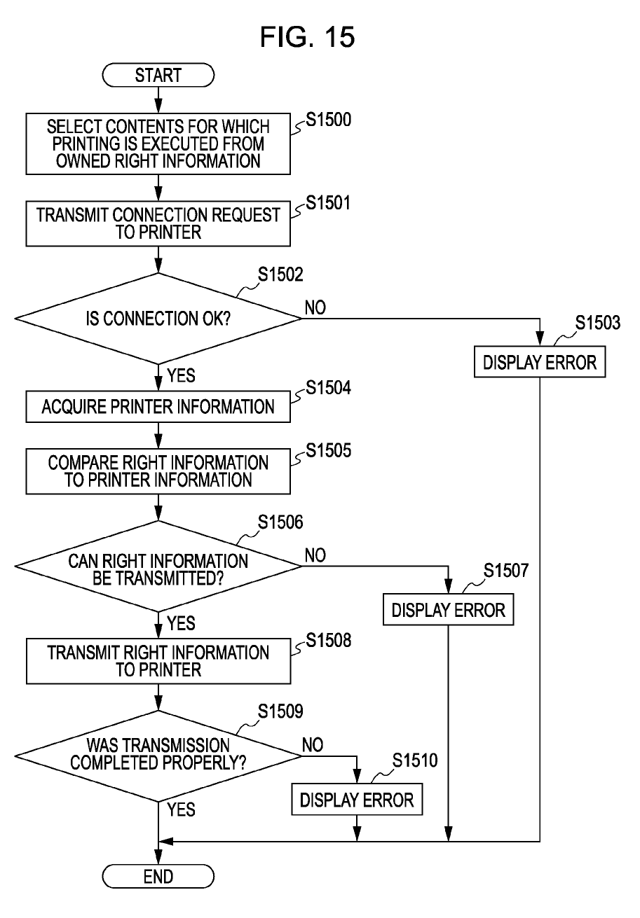

FIG. 15 shows an exemplary flow of processing procedures performed by the CPU 401 of the mobile phone 104, the processing procedures corresponding to from when the right information is transmitted from the mobile phone 104 to the printer 105 to when the right information is stored in the printer 105.

First, the CPU 401 of the mobile phone 104 selects contents for which printing is performed from among the right information stored in the memory unit 406 at step S1500. At that time, on the mobile phone 104, a preview image on which data is extracted from the right information stored in the memory unit 406 of the mobile phone 104 is displayed on the display unit 405 of the mobile phone 104, as a means for making the user select contents. Further, when a plurality of right-information items is stored, a user interface configured to make the display unit 405 display a plurality of preview images and select one of the preview images is presented.

Next, the mobile phone 104 issues a request for connection from the data-communication-transmission-and-reception unit 413 to the data-communication-transmission-and-reception unit 308 of the printer 105 by using a communication means including IrDA, Bluetooth, etc. at step S1501.

If the connection is not properly established at step S1502 (NO in step S1502), the mobile phone 104 displays error data on the display unit 405 of the mobile phone 104 at step S1503 and terminates the processing.

If the connection is properly established at step S1502 (YES in step S1502), the CPU 401 of the mobile phone 104 acquires the printer information from the printer 105 at step S1504. Here, the printer information including data on the manufacturer, the type name, the specification-compatibility status, the capability (the compatible-sheet size, the sheet type, and the compatible character code), the status (the error state, the remaining sheets, the amount of remaining ink, and the network-active state), etc. The printer information is temporarily stored in the memory unit 406.

Next, the printer information stored in the memory unit 406 is compared to the detailed-content information included in the right information of the selected contents, where the detailed-content information includes the type-specific information, information about the print sheet, etc. at step S1505.

As a result, some kind of problems such as disagreement between the print-sheet information included in the right information and the size of a sheet compatible with the printer 105 connected to the mobile phone 104 may occur so that the right information is transmitted to the printer 105 with difficulty at step S1506 (NO in step S1506). In that case, the mobile phone 104 displays an error on the display unit 405 of the mobile phone 104 at step S1507 and terminates the processing.

The printer information is compared to the detailed-content information included in the right information at step S1505, where the detailed-content information includes the type-specific information, the print-sheet information, etc. If the comparison result shows that the right information can be transmitted at step S1506 (YES in step S1506), the CPU 401 performs control so that the right information is transmitted to the printer 105 at step S1508.

If the right information is transmitted from the mobile phone 105 to the printer 105 and the printer 105 properly receives the right information (YES in step S1509), the processing is terminated at step S1509. On the other hand, if the right information is transmitted from the mobile phone 104 to the printer 105 and the printer 105 improperly receives the right information (NO in step S1509), an error is displayed on the display unit 405 of the mobile phone 104 and the processing is terminated in step S1510.

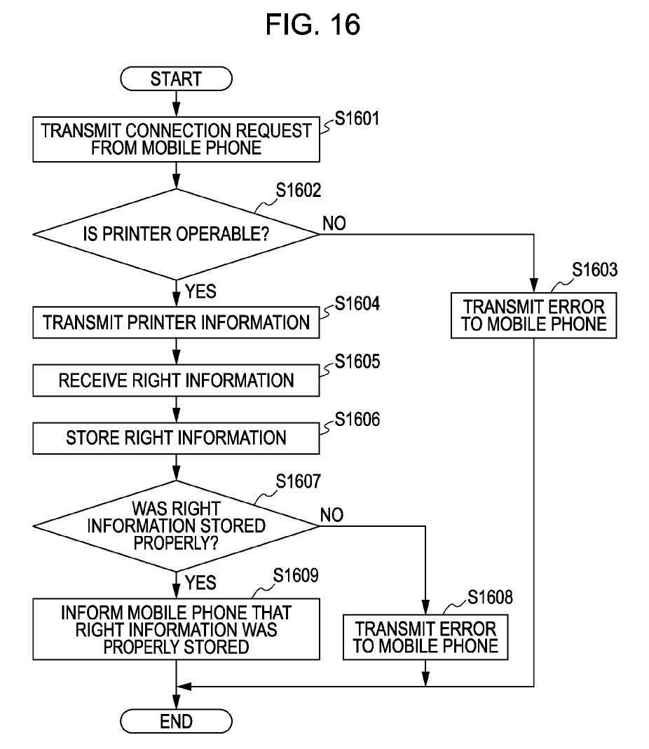

FIG. 16 shows an exemplary flow of processing procedures performed by the CPU 301 of the printer 105, the processing procedures corresponding to from when the right information is transmitted from the mobile phone 104 to the printer 105 to when the right information is stored in the printer 105.

First, the data-communication-transmission-and-reception unit 413 of the mobile phone 104 issues a connection request to the data-communication-transmission-and-reception unit 308 of the printer 105 by using a communication means including IrDA, Bluetooth, etc. at step S1601.

If it is difficult to perform printing based on a request transmitted from the mobile phone 104 because the printer 105 is in the error state (NO in step S1602), or executing print operations based on a request transmitted from an external-processing device (not shown), for example, at step S1602, control is performed so that data on an error is transmitted to the mobile phone 104 at step S1603 and the processing is terminated.

If the printer 105 is in an operable state (YES in step S1602), control is performed so that the printer information is transmitted to the mobile phone 104 at step S1604.

When data on the result of a comparison made by the mobile phone 104 is transmitted to the printer 105, the comparison being made between the printer information transmitted from the printer 105 and the detailed-content information stored in the mobile phone 104, and when the target contents can be printed, right information is transmitted from the mobile phone 104. Therefore, the printer 105 receives the right information transmitted from the mobile phone 104 at step S1605 and stores the right information in the image memory 303 at step S1606.

If the right information is stored properly at step S1607 (YES in step S1607), the mobile phone 104 is informed that the right information is stored properly and the processing is terminated at step S1609. On the other hand, if the right information is not stored properly at step S1607 (NO in step S1607), the mobile phone 104 is informed of an error at step S1608 and the processing is terminated.

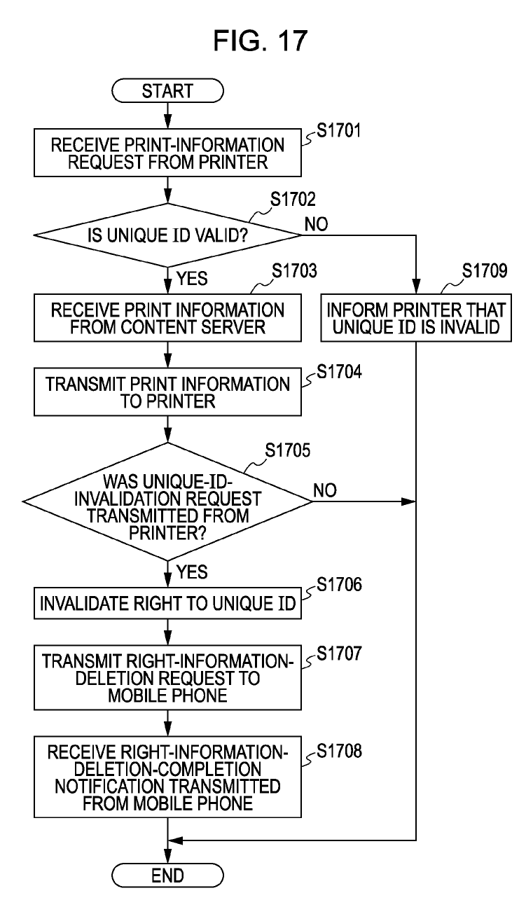

FIG. 17 shows an exemplary flow of processing procedures performed by the CPU 501 of the right-management server 103 according to the first embodiment so that the printer 105 which is ready for a network acquires the print information from the server 101 via the network 106, as shown in FIG. 11.

Further, data is transferred between the printer 105 and the right-management server 103 via the LAN-control unit 514.

The CPU 501 receives a request for the print information, where the request is transmitted from the printer 105, at step S1701. At that time, preview-image data extracted from the right information stored in the image memory 303 of the printer 105 is displayed on the display unit 315 of the printer 105, as a means for making the user select contents in the printer 105. Further, if a plurality of right-information items is stored, a user interface which allows for displaying a plurality of preview images and selecting one of the preview images is provided. Then, the unique-ID-management unit 511 confirms whether the unique ID that is added to the print-information request and that is transmitted from the printer 105 is valid at step S1702. If the unique ID is invalid at step S1702 (NO in step S1702), the printer 105 is informed that the unique ID is invalid at step S1709 and the flow is terminated. If the unique ID is valid at step S1702 (YES in step S1702), the print information is received from the content server 102 at step S1703 and the received print information is transmitted to the printer 105 at step S1704. At that time, the received print information is temporarily accumulated in the RAM 510, and transmitted to the printer 105.

Upon receiving a request to invalidate the unique ID, the request being transmitted from the printer 105, at step S1705 (YES in step S1705), the unique-ID-management unit 511 invalidates the right to the unique ID corresponding to the request at step S1706. If no unique-ID-invalidation request is transmitted from the printer 105 at step S1705 (NO in step S1705), the flow is terminated.

After the right to the corresponding unique ID is invalidated at step S1706, a request to delete the right information is issued to the mobile phone 104 at step S1707. A notification that the right-information deletion is completed is transmitted from the mobile phone at step S1708 and the flow is terminated.

In the above-described embodiment, the invalidation of the unique ID is performed upon receiving the unique-ID-invalidation request transmitted from the printer 105. However, it may be arranged that the invalidation of the unique ID is performed when the transmission of the print information to the printer 105 is properly finished at step S1704.

Further, in the above-described embodiment, the request for the right-information deletion is issued to the mobile phone 104 at the same time as when the unique ID is invalidated. However, the right-management server 103 is not necessarily capable of connecting with the mobile phone 104 at that time. Therefore, without issuing the right-information-deletion request at that time, the mobile phone 104 may inquire of the right-management server 103 whether the unique ID is valid at time appropriate for the mobile phone 104 so that the invalid right information is deleted.

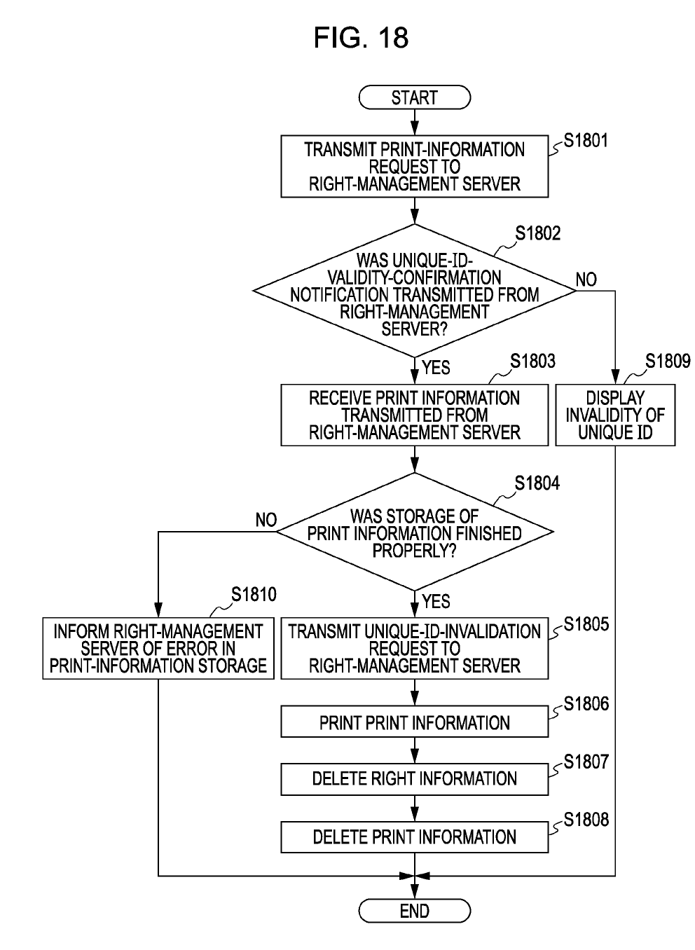

FIG. 18 shows an exemplary flow of processing procedures performed by the CPU 301 of the printer 105 so that the printer 105 ready for the network acquires the print information from the server 101 via the network 106, as shown in FIG. 11. Data communications are executed between the printer 105 and the right-management server 103 via the LAN-control unit 306.

Of the right information stored in the image memory 303, the CPU 301 of the printer 105 acquires, at least, the unique ID. Then, the CPU 301 generates a request for print information including the unique ID and request the right-management server 103 to transmit the print information at step S1801. Upon receiving a notification indicating that the confirmation of the validity of the unique ID is completed, where the notification is transmitted from the right-management server 103 (YES in step S1802), at step S1802, the CPU 301 receives the print information transmitted from the right-management server 103 at step S1803.

If a notification that the unique ID is invalid is transmitted from the right-management server 103 at step S1802 (NO in step S1802), the CPU 301 displays a message indicating that the unique ID is invalid on the operation-and-display unit 315 of the printer 105 at step S1809 and terminates the flow.

After the reception of the print information is finished at step S1803, the print information is stored in the image memory 303 at step S1804. If the print-information storage is not properly finished at step S1804 (NO in step S1804), the right-management server 103 is notified that the print-information storage ended in failure at step S1810 and the flow is terminated. If the print-information storage is properly finished at step S1804 (YES in step S1804), the CPU 301 requests the right-management server 103 to invalidate the unique ID at step S1805. Subsequently, the print information is printed at step S1806, the right information is deleted at step S1807, and the print information is deleted at step S1808 so that the flow is terminated.

According to an embodiment of the present invention, in a print system configured to acquire contents-for-printing available on the network via a mobile phone and print the contents-for-printing, occasions when the mobile phone is occupied for printing the contents and/or occasions when the content printing is suspended can be minimized.

Further, the user can print desired contents at arbitrary time and effectively use a multifunction mobile phone.

Further, it becomes possible to reduce unauthorized duplication of the print information by managing the right to printing through the use of the unique ID uniquely identifying the right to print the contents and controlling whether the print-information download should be performed. Further, it becomes possible to reduce occasions when the printing right acquired by the user is accidentally invalidated by determining whether the printing should be performed based on the printer information and the detailed-content information included in the right information before issuing the request for the print information.

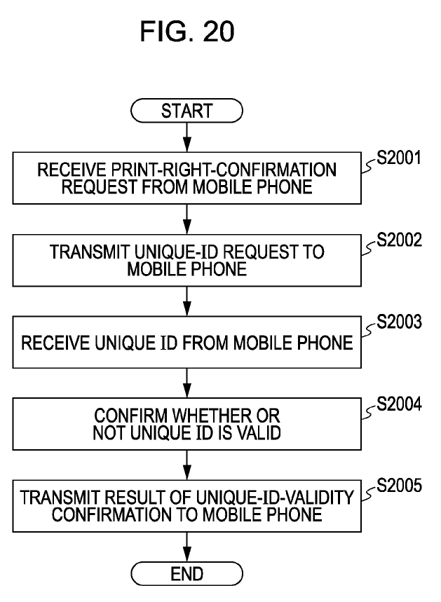

FIG. 20 shows an exemplary flow of processing procedures performed by the CPU 501 of the right-management server 103 according to the first embodiment when the right information stored in the mobile phone 104 is deleted, as shown in FIG. 12.

According to the first embodiment, the right-information-deletion request may be transmitted to the mobile phone 104 after invalidating the unique ID in the right-management server 103 so that the right information is deleted, as shown in FIG. 11. However, the right-management server 103 is not necessarily capable of connecting with the mobile phone 104 at that time. Therefore, the right information may be deleted according to the method shown in FIG. 12 and/or both the methods shown in FIGS. 11 and 12.

Upon receiving the print-right-confirmation request transmitted from the mobile phone 104 at step S2001, the CPU 501 requests the unique ID from the mobile phone 104 at step S2002. Upon receiving the unique ID owned by the mobile phone 104 at step S2003, the CPU 501 makes the unique-ID-management unit 511 check whether the received unique ID is valid or invalid at step S2004, and transmits data on the check result to the mobile phone 104 at step S2005.

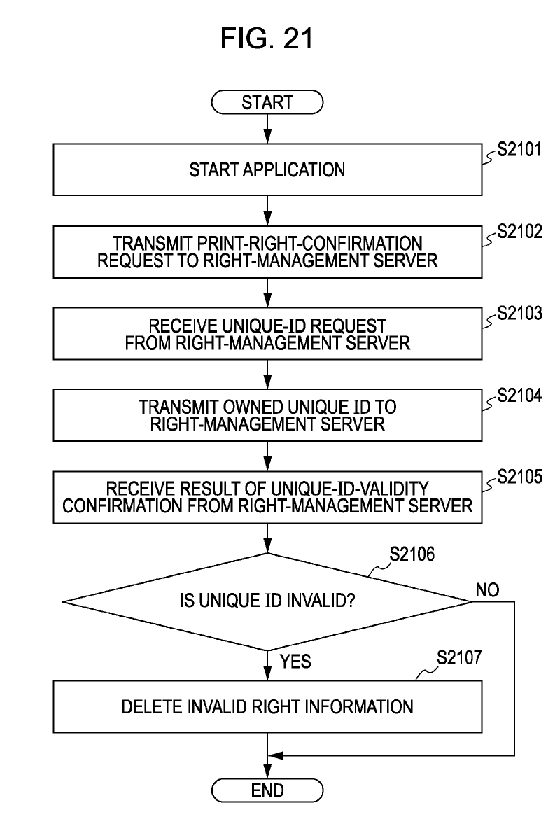

FIG. 21 shows an exemplary flow of processing procedures performed by the CPU 401 of the mobile phone 104 according to the first embodiment when the right information stored in the mobile phone 104 is deleted, as shown in FIG. 12. According to the first embodiment, the right-information-deletion request may be transmitted to the mobile phone 104 after invalidating the unique ID in the right-management server 103 so that the right information is deleted, as shown in FIG. 11. However, the right-management server 103 is not necessarily capable of connecting with the mobile phone 104 at that time. Therefore, the right information may be deleted according to the method shown in FIG. 12 and/or both the methods shown in FIGS. 11 and 12.

The CPU 401 starts the application according as the user operates the operation unit 404 of the mobile phone 104 at step S2101. The CPU 401 transmits the print-right-confirmation request to the right-management server 103, so as to make an inquiry, at step S2102. Upon receiving a request for the unique ID, where the request is transmitted from the right-management server 103, at step S2103, the CPU 401 transmits the unique-ID data stored in the memory unit 406 at step S2104. Then, the CPU 401 receives data on the result of a confirmation of the validity of the unique ID, where the result data is transmitted from the management server 103, at step S2105. Next, the CPU 401 checks the result of the confirmation of the validity of the unique ID, where data on the result is transmitted at step S2105, at step S2106. If the unique ID is valid (NO in step S2106), the flow is terminated. If the unique ID is invalid (YES in step S2106), the right information including the unique ID is deleted from the memory unit 406 at step S2107. The right information stored in the mobile phone 104 can be updated by performing the processing procedures shown in FIG. 21 for the individual right-information items stored in the memory unit 406 of the mobile phone 104.

Thus, the deletion of the right information is performed at the time when the mobile-phone application is started so that unnecessary right information can be deleted even though it is difficult to establish a connection between the mobile phone and the right-management server at the time when the download of the print information is completed.

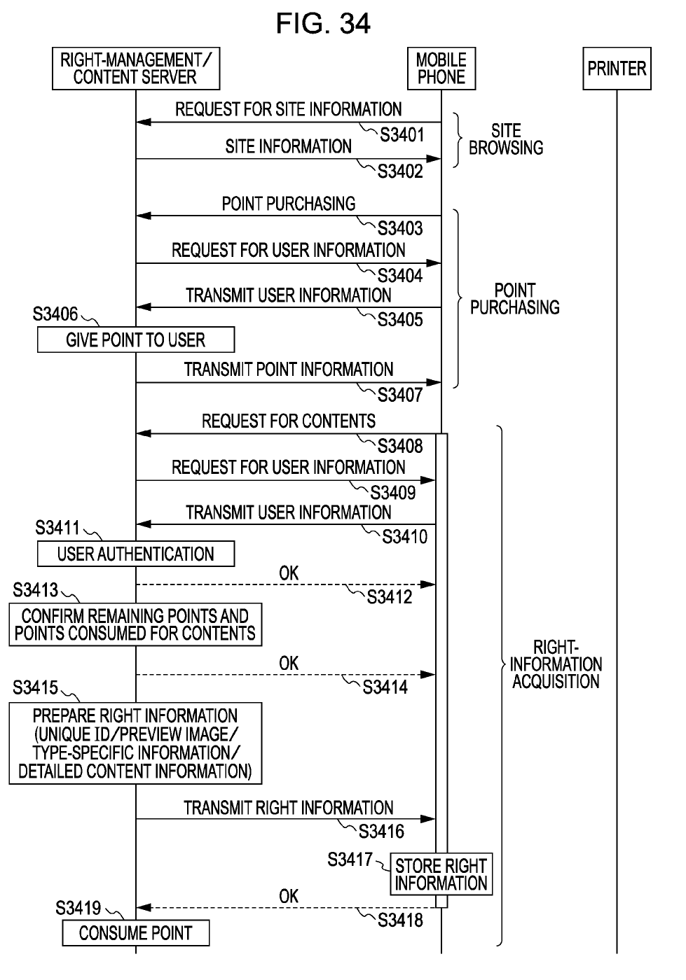

According to the above-described embodiment, the content server and the right-management server independently exist, as shown in FIG. 1. However, even though the above-described servers are integrated with each other, the right information can also be acquired in the above-described manner. FIG. 34 is a sequence diagram provided to illustrate the acquisition of the right information in the configuration where the servers are integrated with each other. Since the processing procedures performed in the mobile phone are not especially changed due to the configuration where the servers are integrated with each other, the description of the sequence diagram is omitted here.

### Second Embodiment

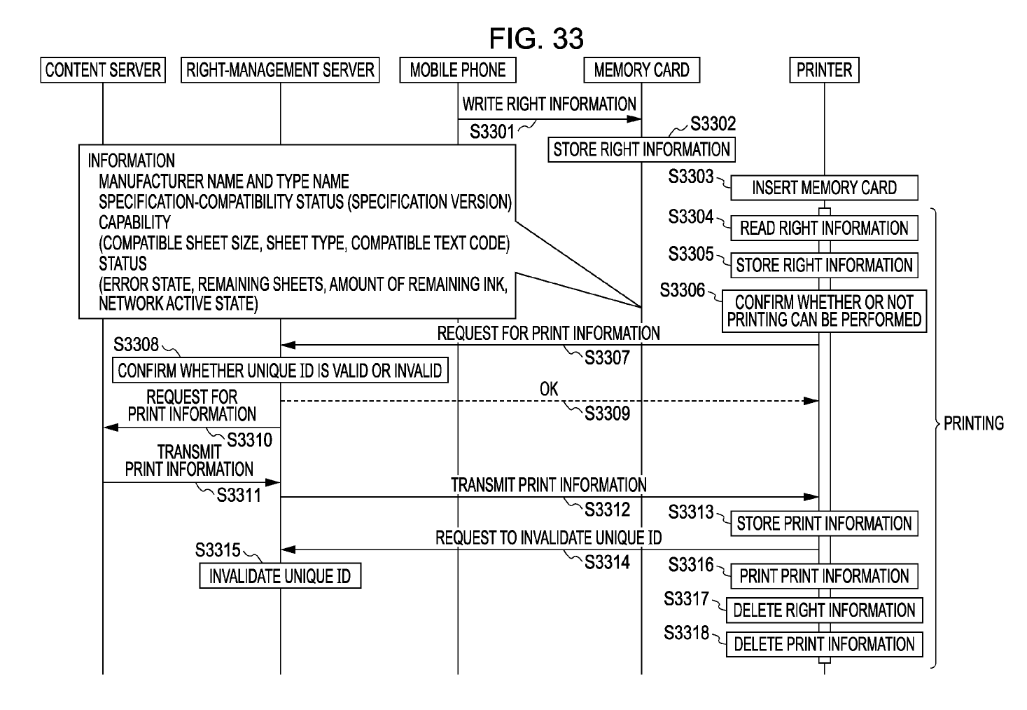

According to a sequence diagram shown in FIG. 33, first, the mobile phone acquires the right information including the unique ID, where the right information is transmitted from the right-management server, as shown in FIG. 10, and the user transfers the right information to the printer at arbitrarily time. Further, the print information of the contents corresponding to the right information is downloaded on the basis of the acquired right information.

According to FIG. 10, the downloaded right information is transferred to the printer by performing data communications based on IrDA, Bluetooth, etc. However, in a second embodiment of the present invention, the right information downloaded to the mobile phone is temporarily accumulated in a removable memory card inserted into the mobile phone, and the memory card is inserted into the printer so that the printer can use the right information.

The right information downloaded from the right-management server to the mobile phone is written and stored in the memory card inserted into the mobile phone at steps S3301 and S3302.

The user removes the memory card from the mobile phone at arbitrary time and inserts the memory card into the card slot of the printer at step S3303.

The printer reads the right information from the inserted memory card and stores the read right information in a memory such as a RAM provided in the printer at steps S3304 and S3305.

After that, the printer confirms whether the print information corresponding to the right information can be printed based on the stored right information and the capability of the printer at step S3306. If the print information can be printed, a request for the print information is transmitted to the right-management server via the network at step S3307.

Since the sequence of the processing procedures corresponding to the above-described steps S3307 to S3318 is the same as that of the processing procedures corresponding to the steps S1101 to S1112 that are described in FIG. 11, the description thereof is omitted.

Thus, the use of the memory card allows for transmitting the right information to the printer and downloading desired print information even though the mobile phone and/or the printer does not have the function of performing data communications by using IrDA, Bluetooth, etc.

Further, as for the time when the right information is read from the memory card at step S3304, the right information may be read on the basis of information transmitted from the operation unit of the printer when the operation unit is operated by the user and/or read automatically at the time when the card is inserted.

### Third Exemplary Embodiment

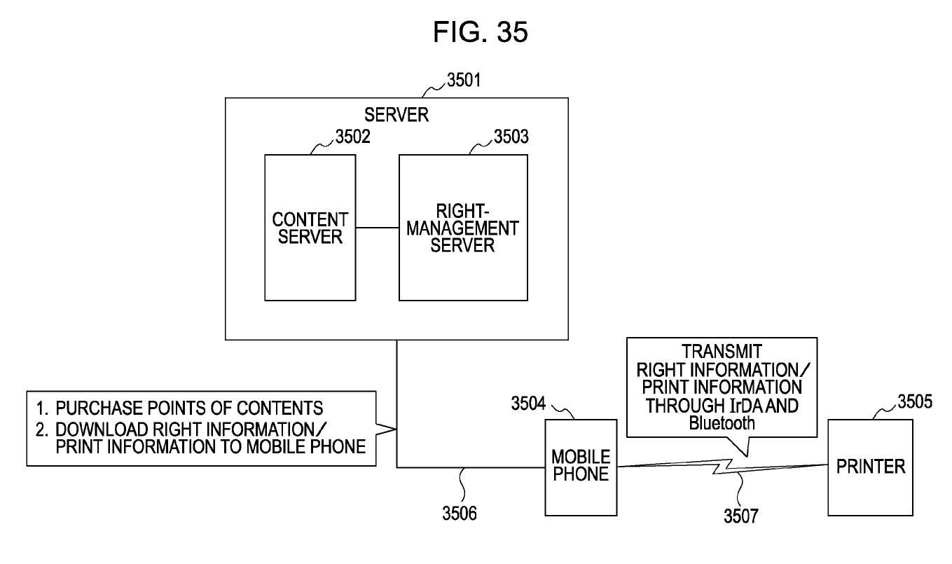

FIG. 35 illustrates a system configured to download print information without using the network 106 shown in FIG. 1. A mobile phone 3504 stores right information downloaded from a server 3501 via a communication line 3506. Then, the mobile phone 3504 downloads the print information from a server without transmitting the right information to a printer 3505, and transfers the right information and the print information to the printer 3505 through a data communication 3507. Namely, the system is configured to download the right information and the print information through the communication line 3506 and the data communication 3507.

The configurations of the server 3501 and the mobile phone 3504 are the same as those of the server 101 shown in FIG. 5 and the mobile phone 104 shown in FIG. 4. If the functions of individual blocks of the server 3501 and the mobile phone 3504 are partly different from those of individual blocks of the server 101 and the mobile phone 104, the differences will be described, as occasions arise.

The printer 3505 has the same configuration as that of the printer 104 shown in FIG. 3 except that the LAN-control unit is removed. If the functions of the individual blocks of the printer 3505 are partly different from those of the individual blocks of the printer 105, the differences will be described as occasions arise, as described above.

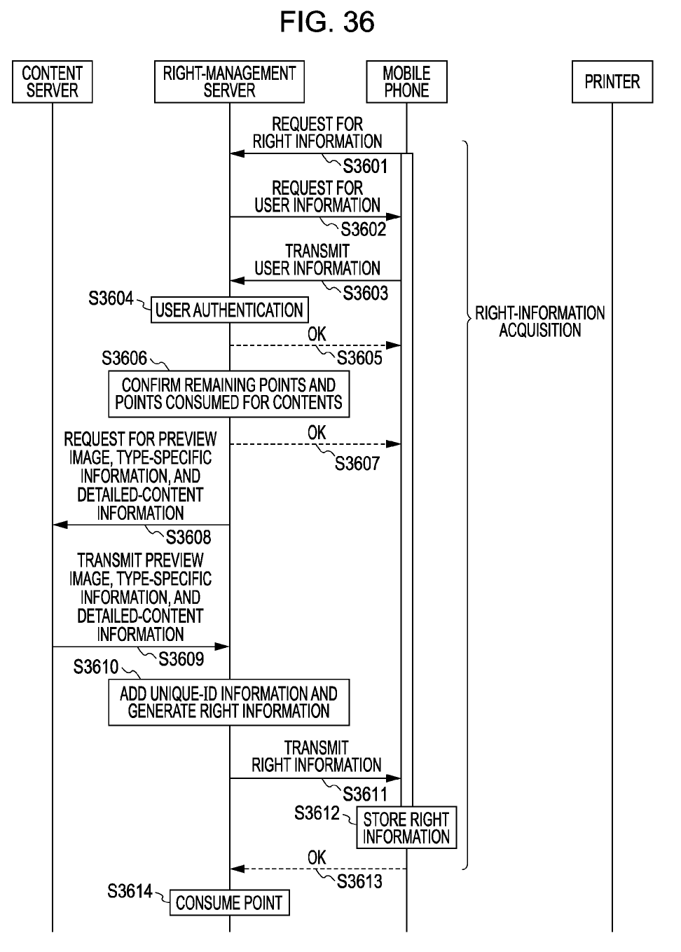

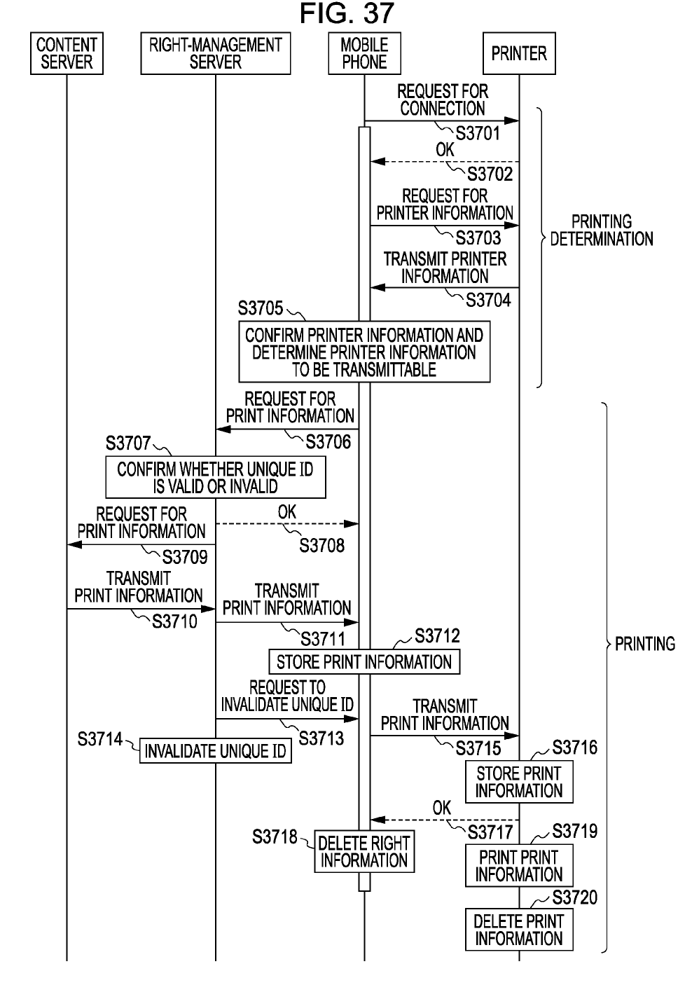

FIGS. 36 and 37 illustrate the sequence of processing procedures corresponding to from when the right to print contents is acquired to when print information of the contents is printed in the system shown in FIG. 35.

FIG. 36 is an exemplary sequence diagram illustrating the processing procedures corresponding to from when a mobile phone acquires the right to print the contents to when the mobile phone downloads right information. Since the sequence step S3601 to step S3614 are the same as that of the above-described processing procedures corresponding to step S908 to step S921 as shown in FIG. 9, the description thereof is omitted.

FIG. 37 is an exemplary sequence diagram illustrating that the mobile phone and the printer confirm the printer information, so as to allow the mobile phone to print the print information transmitted from the server, and the mobile phone downloads the print information from the server and prints the print information through the printer.

The sequences shown in FIGS. 10 and 37, where the sequences are performed in the system shown in FIG. 1, are different from each other in that only the printer information is exchanged and the right information is not transferred to the printer. Since steps S3701 to S3705 that are shown in FIG. 37 are the same as steps S1001 to S1005 that are shown in FIG. 10, the description thereof is omitted.

If it is determined, at step S3705, that the print information can be printed by the printer based on the right information downloaded at step S3611 shown in FIG. 36 and the printer information acquired at step S3704, the mobile phone requests the right-management server to transmit the print information. At that time, the mobile phone generates a request for print information including, at least, the unique ID of the right information downloaded in advance, and transmits the generated print-information request to the right-management server at step S3706.

In response to the request transmitted from the mobile phone, the right-management server confirms the validity of the unique ID at step S3707. If the unique ID is valid, the right-management server informs the mobile phone that the confirmation is done at step S3708 and issues a request for the print information to the content server at step S3709.

The content server responds to the request issued from the right-management server at step S3710 and the print information owned by the content server is transferred to the mobile phone via the right-management server at step S3711. The mobile phone stores the transferred print information therein at step S3712 and transfers the stored print information to the printer at step S3715. Further, after acquiring the print information, the mobile phone requests the right-management server to invalidate the unique ID at step S3713.

The right-management server performs the invalidation processing in response to the request to invalidate the unique ID at step S3714.

Upon acquiring the print information, the printer stores the print information in the image memory 303 of the printer at step S3716. Then, the printer performs the print processing at step S3719, and deletes the stored print information at step S3720.

The mobile phone receives a notification that the print information is stored, where the notification is transmitted from the printer, at step S3717, and deletes the right information corresponding to the print information at step S3718.

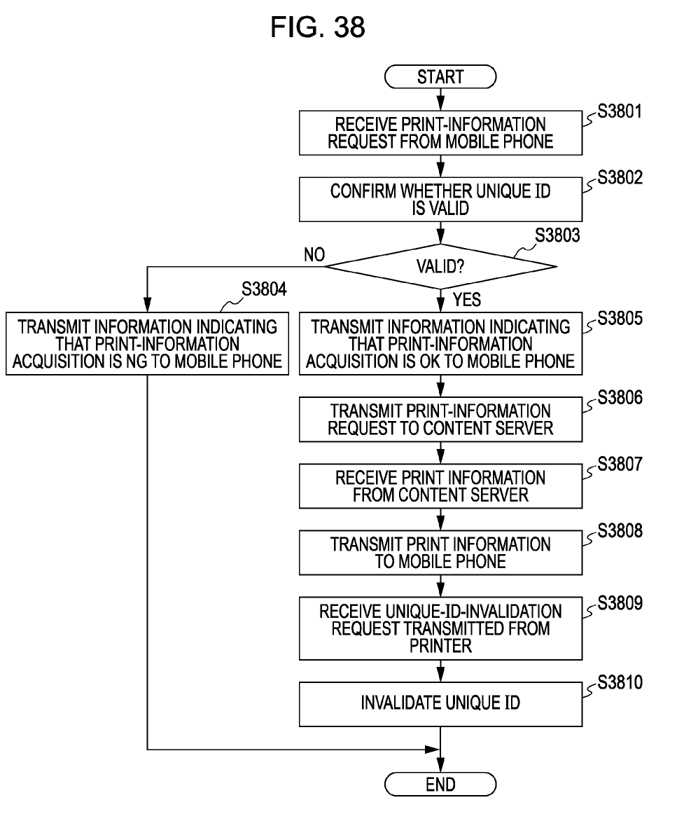

FIG. 38 shows an exemplary flow of processing procedures performed by a right-management server 3503 according to a third embodiment of the present invention, where the processing procedures correspond to from when the mobile phone 3504 shown in FIG. 35 acquires information from the server 3501 to when the information is transmitted to the printer 3505 so that printing is performed, as shown in FIG. 37. The flow will be described based on the configuration diagram shown in FIG. 5 except where specifically noted.

The CPU 501 of the right-management server 3503 starts operating by receiving the print-information request transmitted from the mobile phone 3504 through the network at step S3801.

The unique-ID-management unit 511 confirms the unique ID that is added to the print-information request and that is transmitted at step S3802 and determines whether the unique ID is valid at step S3803. If the unique ID is invalid (NO in step S3803), the mobile phone 3504 is informed that it is difficult to acquire the print information via the LAN-control unit 514 at step S3804 and the flow is terminated. If the unique ID is valid (YES in step S3803), the mobile phone 3504 is informed that the print information is acquired via the LAN-control unit 514 at step S3805 and the processing advances to the next step.

Then, the CPU 501 transmits the print-information request to the content server 3502 at step S3806 and waits until a response to the request is transmitted from the content server 3502.

The CPU 501 receives the print information transmitted from the content server 3502 at step S3807, transmits the print information to the mobile phone 3504 via the LAN-control unit 514 at step S3808, and waits.

After that, the CPU 501 receives the unique-ID-invalidation request transmitted from the mobile phone 3504 at step S3809, invalidates the unique ID stored in the unique-ID-management unit 511 at step S3810, and terminates the flow.

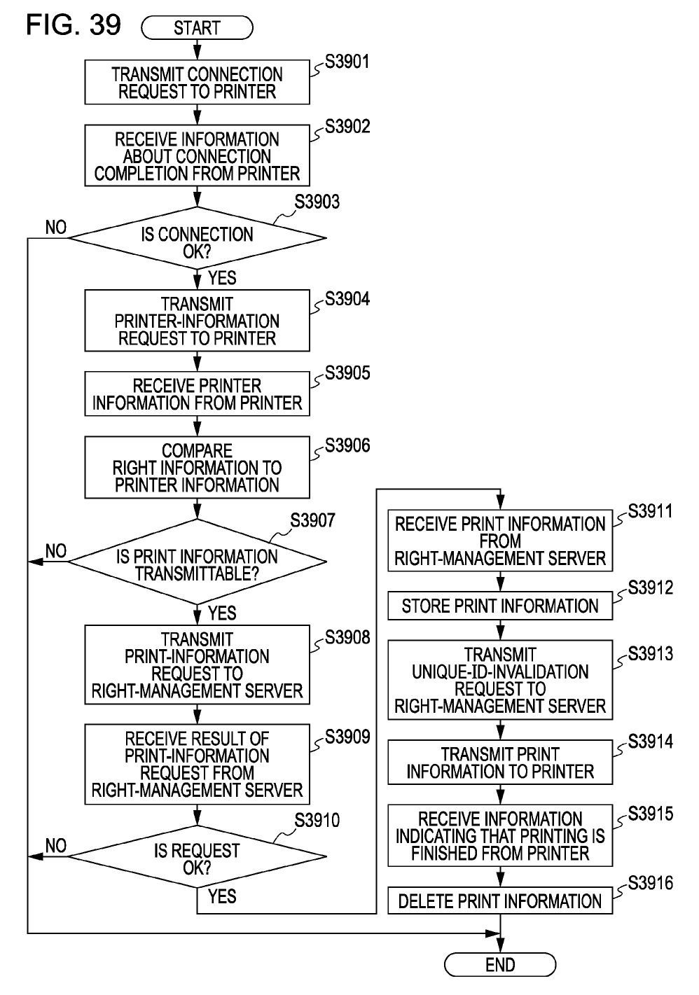

FIG. 39 shows an exemplary flow of processing procedures performed by the mobile phone 3504, where the processing procedures correspond to from when the mobile phone 3504 shown in FIG. 35 acquires information from the server 3501 to when the information is transmitted to the printer 3505 so that the printing is performed, as shown in FIG. 37. The flow will be described based on the configuration diagram shown in FIG. 4 except where specifically noted.

The CPU 401 of the mobile phone 3504 controls the printer 3505 so that the printer transmits the connection request, whereby operations are started, at step S3901. At that time, the mobile phone 3504 and the printer 3505 are connected to each other through a path of some kind for transmitting information via the data-communication-transmission-and-reception unit 413, such as IrDA, Bluetooth, etc.

Upon receiving a connection-completion notification transmitted from the printer 3505 at step S3902, the CPU 401 determines whether the connection is properly finished at step S3903. If the connection ends in failure (NO in step S3903), the CPU 401 terminates the flow. If the connection ends with success (YES in step S3903), the CPU 401 transmits a request for the printer information to the printer 3505 at step S3904 and waits until the printer 3505 responds to the request.

Upon receiving the printer information transmitted from the printer 3505 at step S3905, the CPU 401 compares the detailed-content information included in the right information to the printer information at step S3906, and determines whether the print information can be transmitted to the printer 3505 at step S3907. If it is difficult to transmit the print information to the printer 3505 (NO in step S3907), the flow is terminated. If the print information can be transmitted to the printer 3505 (YES in step S3907), a print-information request including, at least, the unique ID of the right information is generated and transmitted to the right-management server 3503 at step S3908. Then, the CPU 401 waits until the right-management server 3503 responds to the print-information request.

Upon receiving data on a result of the print-information request, where the data is transmitted from the right-management server 3503, at step S3909, the CPU 401 determines whether the print-information request is accepted by the right-management server 3503 at step S3910. If the print-information request is not accepted by the right-management server 3503 (NO in step S3910), the flow is terminated. If the print-information request is accepted (YES in step S3910), the CPU 401 waits until the print information is transmitted from the right-management server 3503.

After receiving the print information transmitted from the right-management server 3503 at step S3911, the CPU 401 stores the print information in the memory unit 406 at step S3912. Next, after transmitting a request to invalidate the unique ID to the right-management server 3503 at step S3913, the CPU 401 transmits the print information to the printer 3505 at step S3914 and waits.

Upon receiving information indicating that the printing is completed, where the information is transmitted from the printer 3505, at step S3915, the CPU 401 deletes the print information stored in the memory unit 406 at step S3916 and terminates the flow.

According to the above-described flow, the print-completion information is transmitted from the printer 3505 at step S3915. However, information indicating that the reception of the print information is completed may be transmitted.

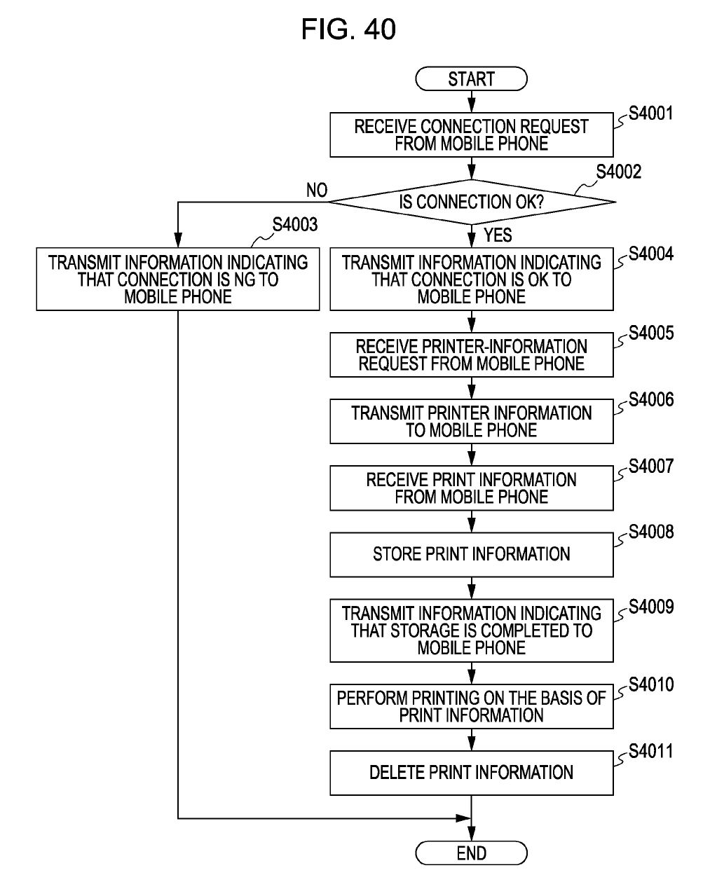

FIG. 40 shows an exemplary flow of processing procedures performed by the printer 3505, the processing procedures corresponding to from when the mobile phone 3504 acquires information transmitted from the server 3501 to when the information is transmitted to the printer 3505 so that printing is performed, as shown in FIG. 37. The above-described flow will be described based on the configuration diagram shown in FIG. 3 except where specifically noted.

The CPU 301 of the printer 3505 starts operations by receiving the connection request transmitted from the mobile phone 3504 at step S4001. At that time, the mobile phone 3504 and the printer 3505 are connected to each other through a path of some kind for transmitting information via the data-communication-transmission-and-reception unit 413, such as IrDA, Bluetooth, etc.

The CPU 301 determines whether the connection can be established in response to the connection request transmitted from the mobile phone 3504 at step S4002. If it is difficult to establish the connection (NO in step S4002), the CPU 301 transmits a connection-completion notification indicating that the connection ends in failure to the mobile phone 3504 at step S4003, and terminates the flow. If the connection can be established (YES in step S4002), the CPU 301 transmits the connection-completion notification indicating that the connection ends with success to the mobile phone 3504 at step S4004, and waits until the printer-information request is transmitted from the mobile phone 3504.

Upon receiving the printer-information request transmitted from the mobile phone 3504 at step S4005, the CPU 301 generates the printer information, and transmits the printer information to the mobile phone 3504 at step S4006. Further, the CPU 301 waits until the print information is transmitted from the mobile phone 3504.

Upon receiving the print information transmitted from the mobile phone 3504 at step S4007, the CPU 301 stores the print information in the image memory 303 at step S4008, and transmits a notification that the storage is completed to the mobile phone 3504 at step S4009.

Next, the CPU 301 performs printing in the record unit 319 based on the print information at step S4010. When the printing is finished, the CPU 301 deletes the stored print information from the image memory 303 at step S4011 and terminates the flow.

Further, even though the storage-completion notification is transmitted at step S4009 in the above-described flow, a notification that the printing is completed may be transmitted at step S4010.

Thus, the present invention is effective even though it is difficult to connect the printer to the right-management server via the network. It becomes possible to reduce unauthorized duplication of the print information through the use of the unique ID provided to uniquely identify the right to print the contents. Further, it becomes possible to reduce occasions when the printing right acquired by the user is accidentally invalidated by determining whether printing can be performed based on the printer information and the detailed-content information included in the right information before issuing the request for the print information.

### Fourth Exemplary Embodiment

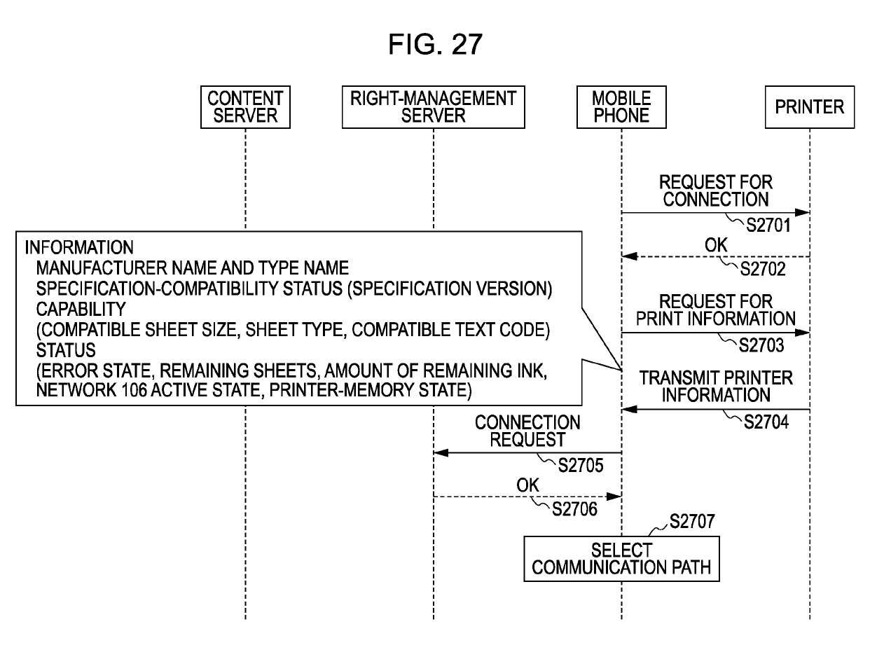

FIG. 27 is an exemplary sequence diagram illustrating a fourth embodiment of the present invention, in which a communication path used to download the print information is selected when printing is performed after the right information of the contents is downloaded to the mobile phone.

Here, the communication path will be described. In the case where a print path 1 is used, the mobile phone 104 downloads the print information from the content server 102 by using the communication line 107, and transmits the print information to the printer by using the data communication 108 so that the print information is printed, as shown in FIG. 35.

On the other hand, in the case where a print path 2 is used, the print information is downloaded from the content server 102 through the use of the network 106 on the basis of the right information transmitted from the mobile phone to the printer so that the print information is printed, as shown in FIG. 1.

In the fourth embodiment, the method of selecting either the print path 1 or the print path 2 on the basis of whether the print path is supported, the connection states of the individual print paths, and the capability of the printer and/or the mobile phone will be described.

The above-described selecting method will be illustrated with reference to FIG. 27. The sequence of communications performed between the content server, the right-management server, the mobile phone, and the printer will be described, as below.

Steps S2701 and S2702 are a sequence performed to issue a connection request so that the mobile phone shown in FIG. 4 communicates with the printer. The mobile phone issues a connection request to the printer at step S2701, and the printer transmits an OK message indicating that the connection is established to the mobile phone in response to the request at step S2702. Thus, communications can be performed between the mobile phone and the printer.

The mobile phone requests the printer to transmit the printer information at step S2703, and the printer transmits the printer information to the mobile phone in response to the request at step S2704. The printer information requested at step S2703 includes data on the manufacturer, the type name, the specification-compatibility status, the capability, the error state, the remaining sheets, the amount of remaining ink, the network-106-active state, the printer-memory state, etc. of the printer. It becomes possible to determine whether the network 106 is in a communicable state by acquiring the above-described printer information. Further, it becomes possible to determine whether the printer has memory large enough to receive the print information transmitted from the mobile phone.

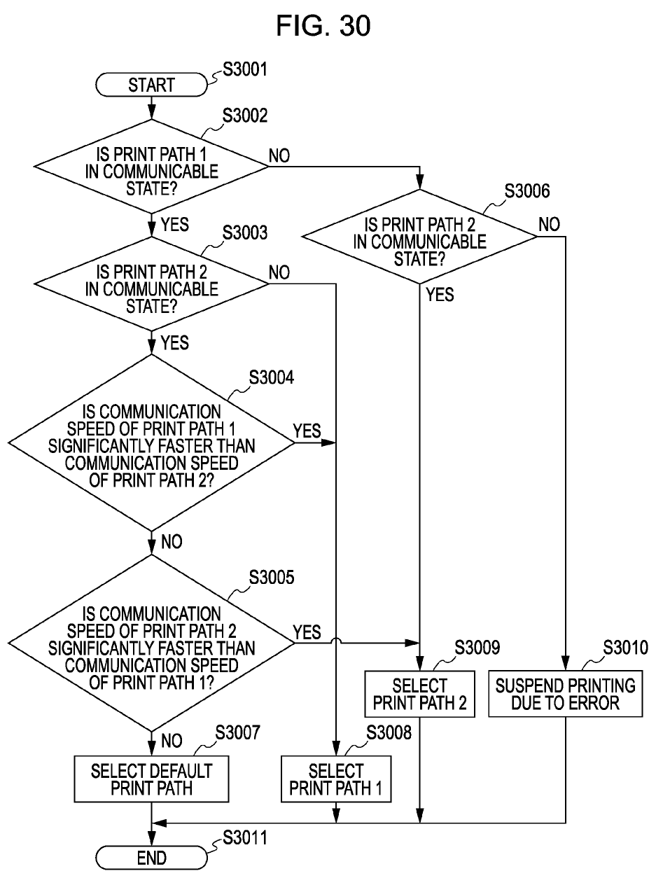

The mobile phone issues a connection request to the right-management server at step S2705, and the right-management server transmits a response to the request to the mobile phone at step S2706. By performing the processing procedures corresponding to steps S2705 to S2709, whether the communication line 107 is in the communicable state can be determined. At step S2707, the communication path is selected based on the result of performing the sequence corresponding to steps S2701 to S2706. The method of selecting the communication path will be described with reference to FIGS. 29 to 32.

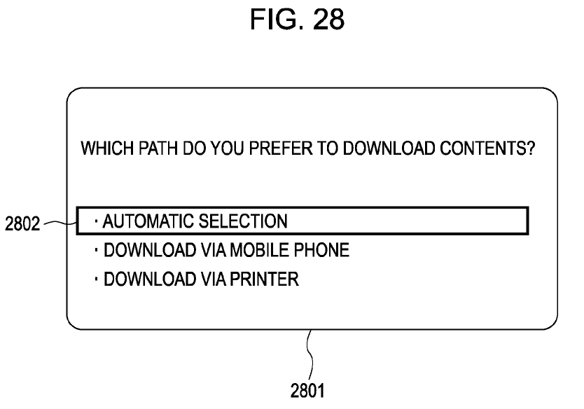

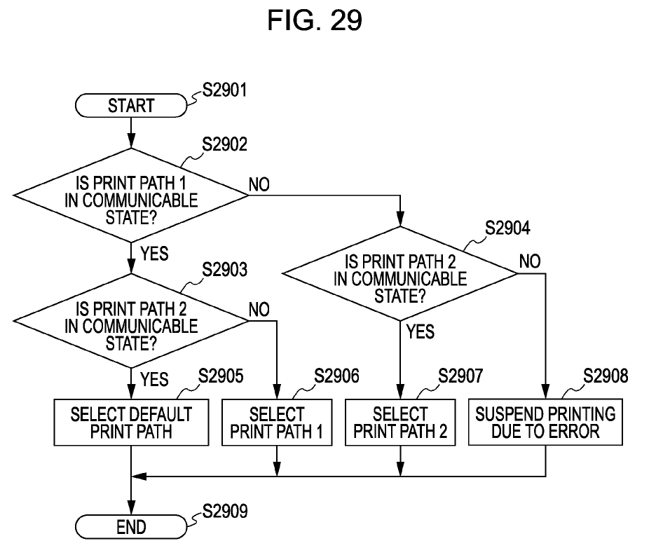

FIG. 28 shows an example image displayed on the display unit 405 of the mobile phone when the communication path through which the print information is downloaded is selected. A screen image 2801 is used to select the print path. The image of a menu used to select the path is displayed on the display unit 405. The user selects the communication path by moving the focus of the menu by operating the operation unit 404.

When the message “automatic selection” (2802) is selected, the mobile phone automatically determines which of the communication path 1 and the communication path 2 should be selected. A default communication path is determined on the assumption that there would be the case where either of the communication path 1 and the communication path 2 can be selected at the automatic-determination time.

When the message “download via mobile phone” is selected, the communication path 1 is selected. When the message “download via printer” is selected, the communication path 2 is selected.

The method of selecting the communication path at step S2707 will be described with reference to FIGS. 29, 30, 31, and 32. FIG. 29 describes an exemplary flow of processing procedures performed by the CPU 401 of the mobile phone, so as to switch between the communication paths 1 and 2 based on the communication states of the communication paths 1 and 2.

The processing starts from step S2901 and advances to step S2902. At step S2902, the CPU 401 determines whether the print path 1 is in the communicable state. The above-described determination can be made by referring to the network-106-active state on which data is included in the printer information transmitted from the printer to the mobile phone at step S2704. If the communication path 1 is in the communicable state (YES in step S2902), the processing advances to step S2903. Otherwise (NO in step S2902), the processing advances to step S2904.

At step S2903, it is determined whether the print path 2 is in the communicable state. The above-described determination can be made by determining whether the communication line 107 is in the communicable state at step S2705 shown in FIG. 27. If the communication path 2 is in the communicable state (YES in step S2903), the processing advances to step S2905. Since both the communication paths 1 and 2 are in the communicable state at step S2905, the default communication path is selected and the processing advances to step S2909. If the print path 1 alone is in the communicable state at step S2903 (NO in step S2903), the communication path 1 is selected at step S2906 and the processing advances to step S2909. At step S2904, it is determined whether the print path 2 is in the communicable state, as is the case with step S2903. If the communication path 2 is in the communicable state (YES in step S2904), the processing advances to step S2907. Otherwise (NO in step S2904), the processing advances to step S2908. At step S2907, the communication path 2 is selected, and the processing advances to step S2909. Since both the communication paths 1 and 2 are not in the communication state at step S2908, which means an error, the printing is suspended and the processing advances to step S2909 at which the flow is terminated.

By performing the above-described flow, the communicable path is automatically selected and the printing can be performed when the user tries to print the print information. Further, even though the path had been determined by selecting the message “download via mobile phone” and/or the message “download via printer” on the screen image shown in FIG. 28, it becomes possible to avoid a path through which communication is performed with difficulty by performing the above-described flow.

Further, the communicable states of the individual communication paths 1 and 2 are checked in the above-described flow. However, the communicable state of the communication path 2 may not be checked. Namely, the communication path 2 may be selected only by simply determining whether the printer is of a type having a network-connection function.

FIG. 30 illustrates an exemplary flow of processing procedures performed by the CPU 401 of the mobile phone, so as to switch between the communication paths 1 and 2 based on the communication states of the communication paths 1 and 2. FIG. 30 is different from FIG. 29 in that the communication speeds of the communication paths 1 and 2 are considered.

The flow starts from step S3001 and advances to step S3002. At step S3002, the CPU 401 determines whether the print path 1 is in the communicable state. The determination can be made by referring to the network-106-active state on which data is included in the printer information transmitted from the printer to the mobile phone at step S2704 shown in FIG. 27. When the communication path 1 is in the communicable state (YES in step S3002), the processing advances to step S3003. Otherwise (NO in step S3002), the processing advances to step S3006.

At step S3003, it is determined whether the print path 2 is in the communicable state. The determination can be made by determining whether the communication line 107 is in the communicable state at step S2705 shown in FIG. 27. If the communication path 2 is in the communicable state (YES in step S3003), the processing advances to step S3004. Otherwise (NO in step S3003), the processing advances to step S3008.

At step S3004, the CPU 401 determines whether the communication speed 1 of the print path 1 is faster than the communication speed 2 of the print path 2. Consequently, the CPU 401 can automatically select and print the print path with a fast communication speed. The threshold value of the communication speed, which becomes the determination reference, may be set for each type. For example, when the communication speed 1 and the communication speed 2 are in a ratio of ten to one or one to ten, one of the speeds may be determined to be faster than the other. Of course, the determination may be made not on the basis of the ratio, but by making a comparison between the communication speeds. When the communication speed 1 is faster than the communication speed 2 (YES in step S3004), the processing advances to step S3008. Otherwise (NO in step S3004), the processing advances to step S3005 at which a comparison is made between the communication speeds, as is the case with step S3004. If the communication speed 2 is faster than the communication speed 1 (YES in step S3005), the processing advances to step S3009. Otherwise (NO in step S3005), the processing advances to step S3007 at which a default print path is selected and the processing advances to step S3011. At step S3008, the print path 1 is selected and the processing advances to step S3011. At step S3006, it is determined whether the print path 2 is in the communicable state similar to S3003. If the communication path 2 is in the communicable state (YES in step S3006), the processing advances to step S3009. Otherwise (NO in step S3006), the processing advances to step S3010. At step S3009, the print path 2 is selected and the processing advances to step S3011. Since both the communication paths 1 and 2 are not in the communicable state at step S3010, which means an error, the printing is suspended and the processing advances to step S3011 at which the flow is terminated.

The user can automatically select a path with a fast communication speed by performing the above-described flow. Further, even though the path is determined by selecting the message “download via mobile phone” and/or the message “download via printer” on the screen image shown in FIG. 28, it becomes possible to avoid a path of which speed is reduced for one reason or another by performing the above-described flow.

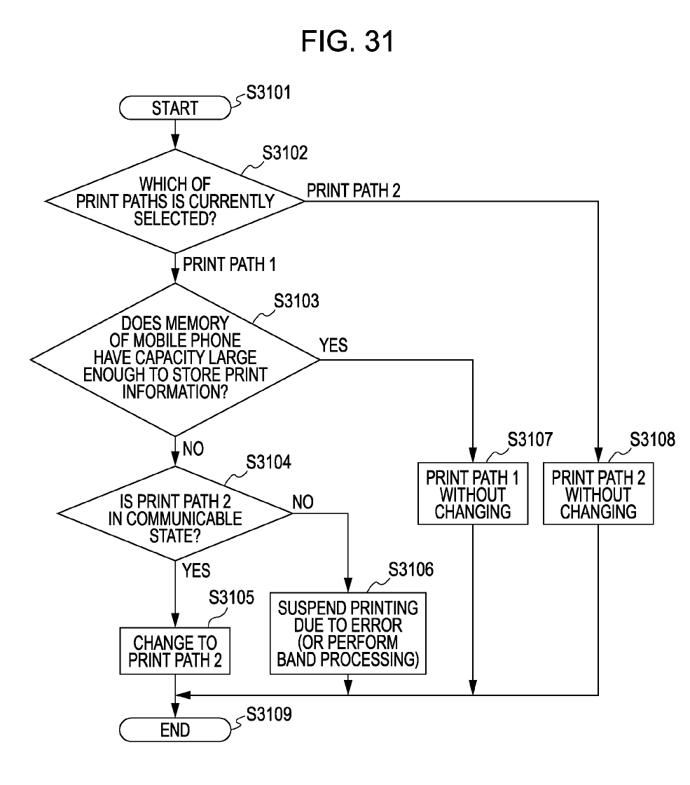

FIG. 31 illustrates an exemplary flow of processing procedures performed by the CPU 401 of the mobile phone, so as to switch between the communication paths based on the memory capacity of the mobile phone.

The flow starts from step S3101 and advances to step S3102 at which the CPU 401 determines the currently selected print path. The currently selected print path may be any one of the print path selected by the user as described in FIG. 28, the print path determined based on the flow shown in FIG. 29, the print path determined based on the flow shown in FIG. 30, and the default print path. If the print path 1 is currently selected, the processing advances to step S3103, and if the print path 2 is currently selected, the processing advances to step S3108.

At step S3103, it is determined whether the memory unit 406 of the mobile phone has a capacity large enough to store the print information. The size of the print information may be recognized by the fact that data on the content size is included in the detailed-content information when requesting data on thumbnails, the type-specific information, and the detailed-content information at step S917 shown in FIG. 9. If the capacity of the memory unit 406 is large enough to store the print information (YES in step S3103), the processing advances to step S3107. Otherwise (NO in step S3103), the processing advances to step S3104.

At step S3104, it is determined whether the print path 2 is in the communicable state, as is the case with step S3003. If the print path 2 is in the communicable state (YES in step S3104), the processing advances to step S3105. Otherwise (NO in step S3104), the processing advances to step S3106. At step S3105, the print path 2 is in the communicable state even though the memory unit 406 of the mobile phone does not have the memory capacity large enough to store the print information. Therefore, the print path is changed to the print path 2 and the processing advances to step S3109. At step S3106, the memory unit 406 of the mobile phone does not have the memory capacity large enough to store the print information and the print path 2 is not in the communicable state. Therefore, the flow is suspended due to an error, or band processing is performed, so as to divide and transmit data while printing is performed through the print path 1, and the processing advances to step S3109. At step S3107, the currently selected print path 1 is used without being changed and the processing advances to step S3109. At step S3108, the currently selected print path 2 is used without being changed and the processing advances to step S3109 at which the above-described flow is terminated.

If the print information is too large in size for the print path 1 selected by the user, which makes it difficult to store the print information in the mobile phone, it becomes possible to automatically switch over to the print path 2 by performing the above-described flow.

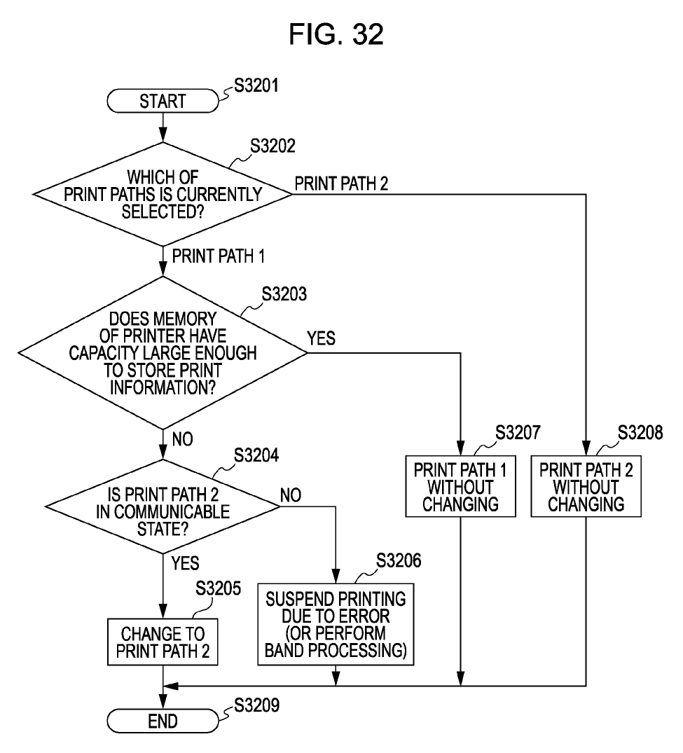

FIG. 32 illustrates an exemplary flow of processing procedures performed by the CPU 401 of the mobile phone, so as to switch over to another communication path based on the memory capacity of the printer.

The flow starts from step S3201 and advances to step S3202 at which the currently selected print path is determined. The currently selected print path may be any one of the print path selected by the user as described in FIG. 28, the print path determined based on the flow shown in FIG. 29, the print path determined based on the flow shown in FIG. 30, and the default print path. If the print path 1 is currently selected, the processing advances to step S3203, and if the print path 2 is currently selected, the processing advances to step S3208.

The image memory 303 of the printer determines whether the capacity is large enough to store the print information at step S3203. The size of the print information can be recognized based on the right information transmitted to the mobile phone at step S918, as the result of issuing a request for the thumbnail data, the type-specific information, and the detailed-content information to the content server at step S915 shown in FIG. 9. The right information includes the detailed-content information showing the size of the print information. The size of the image memory 303 of the printer can be recognized by receiving the printer information transmitted from the printer at step S2704 shown in FIG. 27. The mobile phone analyzes the transmitted printer information and determines whether the image memory 303 of the printer has the memory capacity large enough to download the print information. If the image memory 303 has the above-described memory capacity (YES in step S3203), the processing advances to step S3207. Otherwise (NO in step S3203), the processing advances to step S3204.

At step S3204, it is determined whether the print path 2 is in the communicable state, as is the case with step S3003. If the print path 2 is in the communicable state (YES in step S3204), the processing advances to step S3205. Otherwise (NO in step S3204), the processing advances to step S3206. At step S3205, the print path 2 is in the communicable state even though the image memory 303 of the printer does not have a capacity large enough to store the print information. Therefore, the CPU 401 switches over to the print path 2 and the processing advances to step S3209. At step S3206, the image memory 303 of the printer does not have the capacity large enough to store the print information and the print path 2 is not in the communicable state. Therefore, the flow is suspended due to an error, or the band processing is performed, so as to divide and transmit data while the printing is performed through the print path 1, and the processing advances to step S3209. In that case, even though the printing can be performed, it is difficult for the user to terminate communications performed between the mobile phone and the printer until the printing is finished. At step S3207, the currently selected print path 1 is used without being changed and the processing advances to step S3209. At step S3208, the currently selected print path 2 is used without being changed and the processing advances to step S3209 at which the above-described flow is terminated.

By performing the above-described control, it becomes possible to select a path which is the most appropriate to download the print information. Further, if it is difficult to download the print information through one path, the print information can be downloaded through another path.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-266601 filed on Oct. 12, 2007, which is hereby incorporated by reference herein in its entirety.

What is claimed is:

1. A print system that acquires contents from a server via a mobile terminal and prints the contents through a printer, comprising:
the mobile terminal comprising:
a first request unit configured to request the contents from the server;
a first acquisition unit configured to acquire right information including a print right, the right information being issued from the server;
a second request unit configured to transmit the print right to the server and requests print data corresponding to the print right from the server;
a second acquisition unit configured to acquire and store the print data transmitted from the server; and
a transfer unit configured to transfer the stored print data to the printer;
the server comprising:
an issuing unit configured to issue the right information to the mobile phone based on the contents requested by the first request unit;
a determining unit configured to receive the print right transmitted from the second request unit and determine whether the print right is valid;
a transmission unit configured to transmit the print data corresponding to the print right when it is determined that the print right is valid by the determining unit; and
an invalidation unit configured to invalidate the print right received by the determining unit after the transmission unit transmits the print data;
the printer comprising:
a receiving unit configured to receive the print data transferred from the transfer unit; and
a print unit configured to print the print data received by the receiving unit,
wherein the mobile terminal deletes the print data stored in the second acquisition unit after the transfer performed by the transfer unit is finished.

2. A print system that acquires contents from a server via a mobile terminal and prints the contents through a printer, comprising:
the mobile terminal comprising:
a first request unit configured to request the contents from the server;
a first acquisition unit configured to acquire right information including a print right, the right information being issued from the server;
a second request unit configured to transmit the print right to the server and requests print data corresponding to the print right from the server;
a second acquisition unit configured to acquire and store the print data transmitted from the server; and
a transfer unit configured to transfer the stored print data to the printer;
the server comprising:
an issuing unit configured to issue the right information to the mobile phone based on the contents requested by the first request unit;
a determining unit configured to receive the print right transmitted from the second request unit and determine whether the print right is valid;
a transmission unit configured to transmit the print data corresponding to the print right when it is determined that the print right is valid by the determining unit; and
an invalidation unit configured to invalidate the print right received by the determining unit after the transmission unit transmits the print data;
the printer comprising:
a receiving unit configured to receive the print data transferred from the transfer unit; and
a print unit configured to print the print data received by the receiving unit,
wherein when the second acquisition unit stores the print data, the mobile terminal requests the server to invalidate the print right corresponding to the print data and the print right is invalidated by the invalidation unit.

3. The print system according to claim 1,
wherein the printer further comprising a first notification unit configured to notify the mobile terminal that the printing is finished when the printing performed by the print unit is finished, and
wherein the mobile terminal deletes the print data stored in the second acquisition unit upon receiving a notification transmitted from the first notification unit.

4. The print system according to claim 1, wherein the printer further comprising:
a memory configured to be capable of storing data included in the contents and store the print data received by the receiving unit;
a second notification unit configured to notify the mobile terminal that the reception is finished when the memory receives the print data included in the contents; and
wherein the mobile terminal deletes the print data stored in the second acquisition unit upon receiving a notification transmitted from the second notification unit.

5. The print system according to claim 4, wherein the print right acquired by the first acquisition unit is stored to the memory and mobile terminal deletes the print right upon receiving a notification transmitted from the second notification unit.

6. The print system according to claim 1, wherein the right information issued from the issuing unit further includes data on an image indicating details of the print data.

7. The print system according to claim 6, wherein the mobile phone further comprising:
a memory configured to store the right information acquired by the first acquisition unit;
a display unit configured to display the image on which data is included in the right information stored in the memory; and
an operation unit operated by a user,
wherein at least two images on which data is included in at least two right-information items stored in the memory are displayed on the display unit, and the second request unit requests print data corresponding to at least one image selected from among the at least two images in response to an instruction transmitted from the operation unit.

8. A print method provided to acquire contents from a server via a mobile terminal and print the contents through a printer, the print method comprising:
a first request step at which the mobile terminal requests the contents from the server;
a first acquisition step provided so that right information including a print right is issued from the server to the mobile terminal based on the contents requested at the first request step, and the mobile terminal acquires the print right;
a second request step provided so that the mobile terminal transmits the print right acquired at the first acquisition step to the server and requests print data corresponding to the print right;
a determining step provided so that the server receives the print right transmitted at the second request step and determines whether the print right is valid;
a second acquisition step provided so that when the print right is determined to be valid at the determining step, the server transmits the print data corresponding to the print right to the mobile terminal, and the mobile terminal acquires and stores the print data;
a transfer step provided so that the mobile terminal transfers the print data stored at the second acquisition step to the printer; and
a print step provided so that the printer receives and prints the print data transferred at the transfer step.

9. A print system that acquires contents from a server via a mobile terminal and prints the contents through a printer, comprising:
the mobile terminal comprising:
a first request unit configured to request the contents from the server;
a first acquisition unit configured to acquire right information including a print right, the right information being issued from the server;
a second request unit configured to transmit the print right to the server and requests print data corresponding to the print right from the server;
a second acquisition unit configured to acquire and store the print data transmitted from the server; and
a transfer unit configured to transfer the stored print data to the printer;
the server comprising:
an issuing unit configured to issue the right information to the mobile phone based on the contents requested by the first request unit;
a determining unit configured to receive the print right transmitted from the second request unit and determine whether the print right is valid;
a transmission unit configured to transmit the print data corresponding to the print right when it is determined that the print right is valid by the determining unit; and
the printer comprising:
a receiving unit configured to receive the print data transferred from the transfer unit; and
a print unit configured to print the print data received by the receiving unit.
